(19) United States
(12) Patent Application Publication
(10) Pub. No.: US 2021/0215965 A1
(43) Pub. Date: Jul. 15, 2021

(54) DISPLAY DEVICE

(71) Applicant: SHARP KABUSHIKI KAISHA, Sakai City (JP)

(72) Inventors: HIROAKI ISOBE, Sakai City (JP); HIROMITSU TSUTSUI, Sakai City (JP); KATSUHIKO HIGASHI, Sakai City (JP); HIROYUKI SADA, Sakai City (JP)

(21) Appl. No.: 17/144,597

(22) Filed: Jan. 8, 2021

(30) Foreign Application Priority Data
Jan. 14, 2020 (JP) 2020-003838

(51) Int. Cl. G02F 1/1333

(52) U.S. Cl. CPC G02F 1/133317; G02F 1/133607; G02F 1/13332

(57) ABSTRACT

A display device includes a display panel that has a display surface, a first panel supporting portion that faces the display surface in a normal direction to the display surface with respect to an outer edge of the display panel and that is capable of supporting the outer edge, a second panel supporting portion that faces a side opposite to the display surface in the normal direction with respect to the outer edge and that is capable of supporting the outer edge, and a panel-end-surface-facing portion that is interposed between the first panel supporting portion and the second panel supporting portion in the normal direction and that faces an end surface of the display panel, at least a part of a facing surface that faces the end surface of the display panel being an inclined surface that is inclined with respect to the normal direction.

### CROSS-REFERENCE TO RELATED APPLICATIONS

This application claims the benefit of priority to Japanese Patent Application Number 2020-003838 filed on Jan. 14, 2020. The entire contents of the above-identified application are hereby incorporated by reference.

### BACKGROUND OF THE INVENTION

### 1. Field of the Invention

The technology that the specification discloses relates to a display device.

### 2. Description of the Related Art

Hitherto, as an example of a display device, a display device described in Japanese Unexamined Patent Application Publication No. 2007-52285 has been known. The display device described in Japanese Unexamined Patent Application Publication No. 2007-52285 includes a planar display panel and a window, the display panel having a substantially rectangular flat shape and including a display area on which an image is to be displayed. The display device also includes a bezel that holds the planar display panel by allowing the display area of the planar display panel to be exposed from the window, a planar light source body that is mounted on the bezel so as to face the planar display panel and that illuminates the display area of the planar display panel with planar light, a frame that holds the planar light source body and the planar display panel, and an antireflection body that is provided at at least an inner surface of a portion of the bezel that holds the planar display panel and that reduces reflection of incident light emitted from the planar light source body.

In the display device described in Japanese Unexamined Patent Application Publication No. 2007-52285 above, an antireflection tape constituted by a black PET tape is used as the antireflection body. Although the antireflection tape of this type reduces the reflection of light, there will actually be some reflected light. In Japanese Unexamined Patent Application Publication No. 2007-52285, since the antireflection tape is disposed straight in a normal direction at a display surface of the planar display panel, reflected light from the antireflection tape is more likely to leak from a gap that is formed between the planar display panel and the bezel. In recent years, due to increasing contrast, the screen brightness when a black screen display is performed at the planar display panel is very low. Therefore, when a slight leakage of light as that described above occurs, a problem that the display quality is reduced occurs. In addition to this problem, in recent years, in order to deal with a reduction in the aperture ratio of pixels of the planar display panel due to increasing resolution, since the brightness of the planar light source body is being increased, the antireflection tape is irradiated with a large quantity of light emitted from the planar light source body. This tends to increase the quantity of leaked light, as a result of which the display quality is also more likely to be reduced. Further, in recent years, since a picture frame of the display device is being narrowed, the distance from the antireflection tape to the aforementioned gap is small, and thus light is more likely to leak.

The technology described in the specification of the application is a completed technology based on circumstances such as those described above, and it is desirable to reduce a reduction in display quality.

### SUMMARY OF THE INVENTION

According to an aspect of the disclosure, there is provided a display device including a display panel that has a display surface on which an image is to be displayed, a first panel supporting portion that is disposed so as to face a side of the display surface in a normal direction to the display surface with respect to an outer edge of the display panel and that is capable of supporting the outer edge, a second panel supporting portion that is disposed so as to face a side opposite to the side of the display surface in the normal direction with respect to the outer edge and that is capable of supporting the outer edge, and a panel-end-surface-facing portion that is disposed so as to be interposed between the first panel supporting portion and the second panel supporting portion in the normal direction and that is disposed so as to face an end surface of the display panel, at least a part of a facing surface of the panel-end-surface-facing portion that faces the end surface of the display panel being an inclined surface that is inclined with respect to the normal direction.

### BRIEF DESCRIPTION OF THE DRAWINGS

FIG. 1 is a plan view of a liquid crystal display device according to a first embodiment;

FIG. 2 is a sectional view taken along line A-A of FIG. 1 in the liquid crystal display device;

FIG. 3 is a plan view of a liquid crystal panel that the liquid crystal display device includes;

FIG. 4 is a plan view of a backlight device that the liquid crystal display device includes;

FIG. 5 is a plan view of the liquid crystal panel and the backlight device;

FIG. 6 is a plan view illustrating in an enlarged form the vicinity of a corner of the liquid crystal panel and the backlight device;

FIG. 7 is a sectional view taken along line B-B of FIG. 6 in the liquid crystal display device;

FIG. 8 is a sectional view taken along line C-C of FIG. 6 in the liquid crystal display device;

FIG. 9 is a sectional view of the vicinity of a panel-end-surface-facing portion of a liquid crystal display device according to a second embodiment;

FIG. 10 is a sectional view of the vicinity of a panel-end-surface-facing portion of a liquid crystal display device according to a third embodiment;

FIG. 11 is a sectional view of the vicinity of a panel-end-surface-facing portion of a liquid crystal display device according to a fourth embodiment;

FIG. 12 is a sectional view of the vicinity of a panel-end-surface-facing portion of a liquid crystal display device according to a fifth embodiment;

FIG. 13 is a sectional view of the vicinity of a panel-end-surface-facing portion of a liquid crystal display device according to a sixth embodiment;

FIG. 14 is a sectional view of the vicinity of a panel-end-surface-facing portion of a liquid crystal display device according to a seventh embodiment;

FIG. 15 is a sectional view of the vicinity of a panel-end-surface-facing portion of a liquid crystal display device according to an eighth embodiment;

FIG. 16 is a sectional view of the vicinity of a panel-end-surface-facing portion of a liquid crystal display device according to a ninth embodiment; and

FIG. 17 is a sectional view of the vicinity of a panel-end-surface-facing portion of a liquid crystal display device according to a tenth embodiment.

### DETAILED DESCRIPTION OF THE INVENTION

### First Embodiment

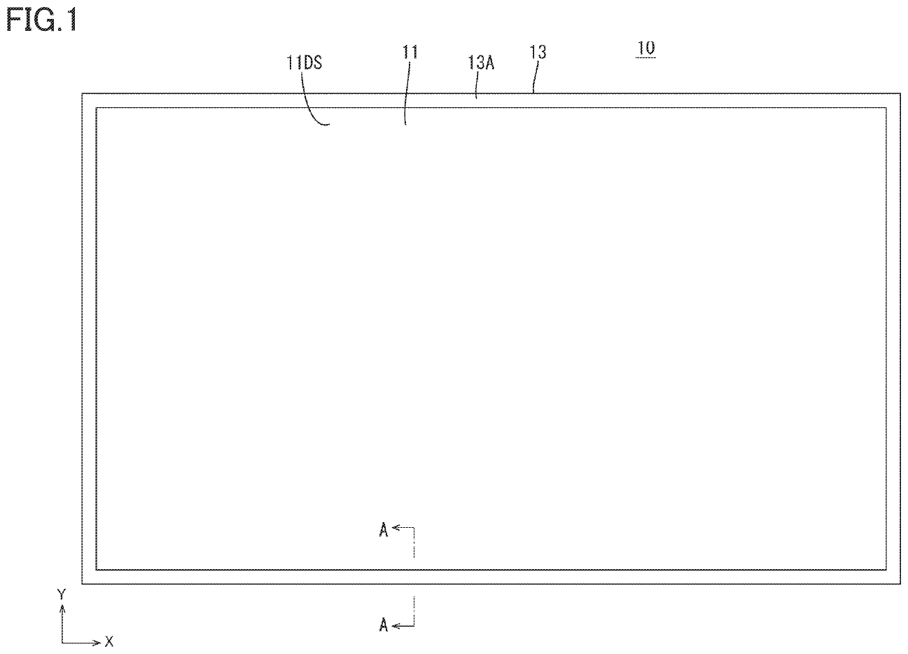

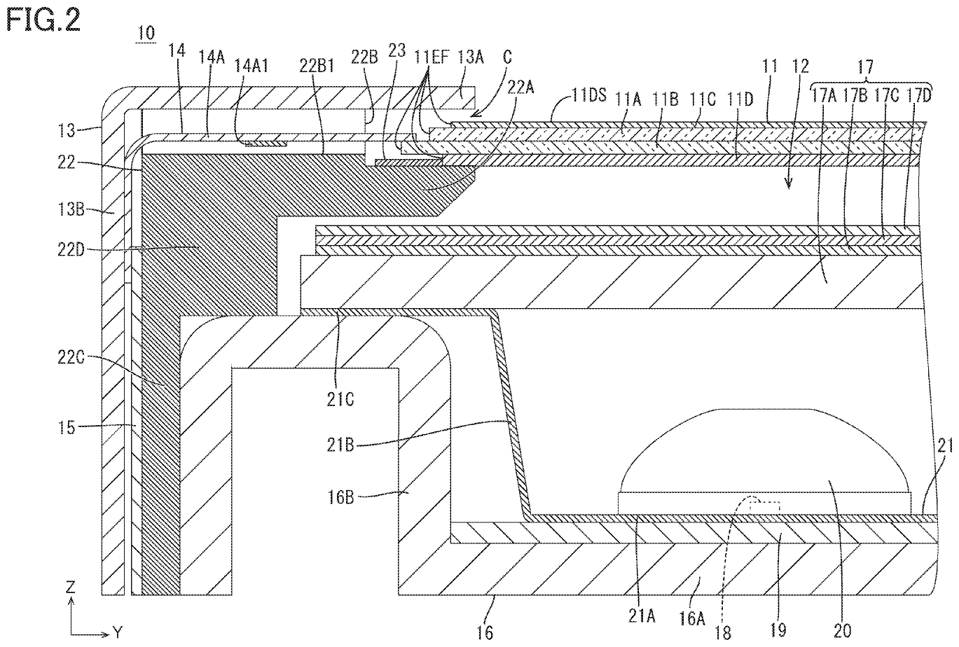

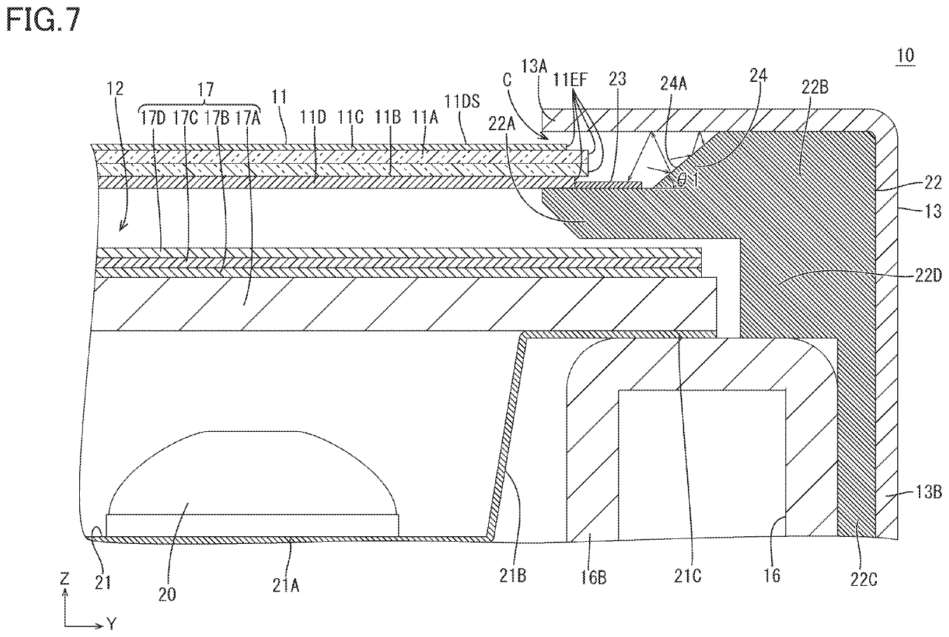

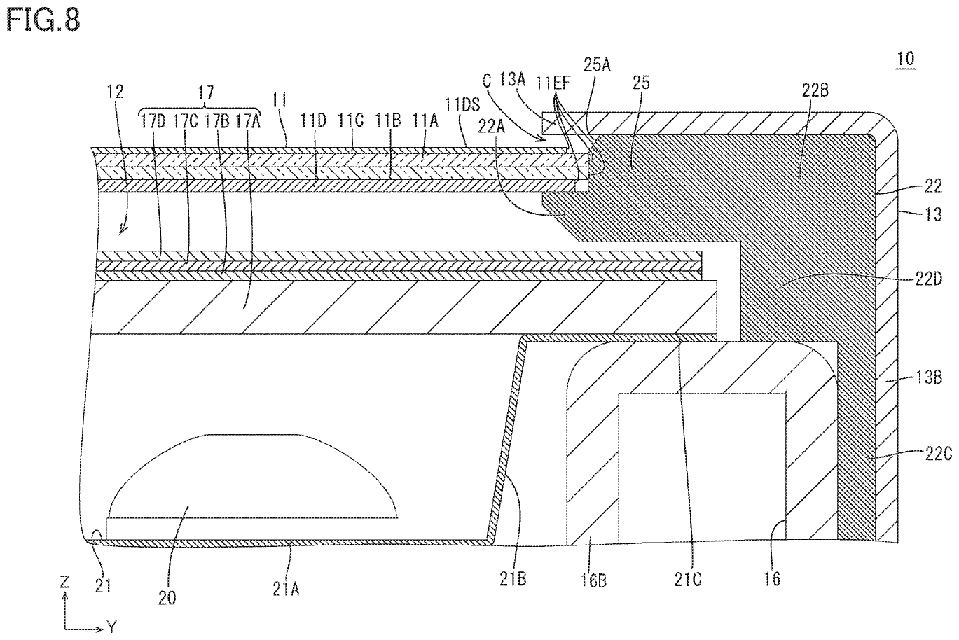

A first embodiment is described with reference to FIGS. 1 to 8. In the embodiment, a liquid crystal display device (a display device) 10 is used as an example. Note that an X axis, a Y axis, and a Z axis are shown in a part of each figure, and each axis direction is indicated so as to become a direction indicated in each figure. An upper side shown in FIG. 2, FIG. 7, and FIG. 8 is defined as a front side, and a lower side shown in these figures is defined as a back side.

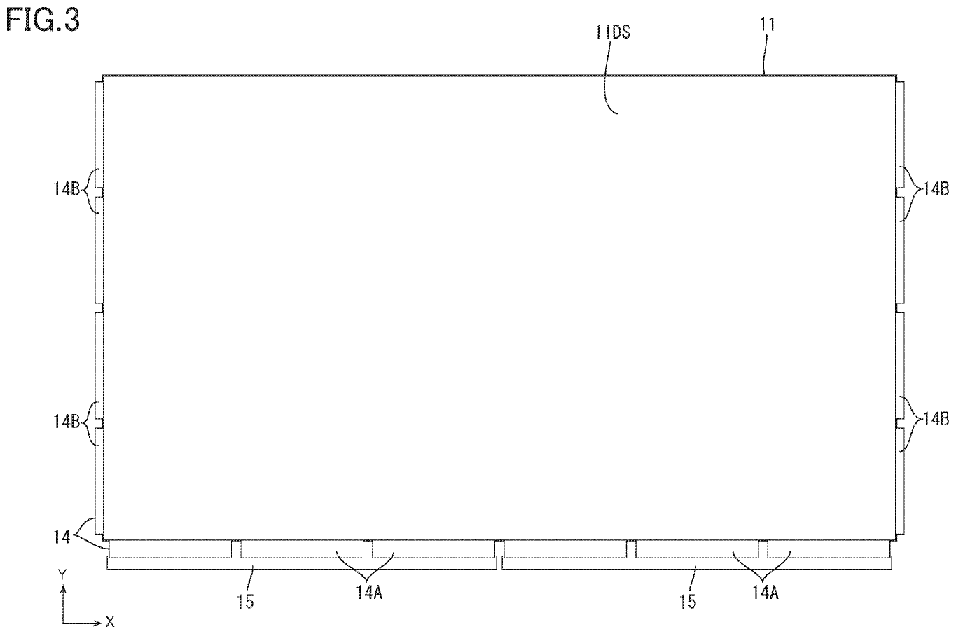

A schematic structure of the liquid crystal display device 10 is described with reference to FIGS. 1 to 3 as appropriate. FIG. 1 is a plan view of the liquid crystal display device 10. As shown in FIG. 1, the liquid crystal display device 10 has, as a whole, a substantially quadrangular shape that is horizontally long. A long-side direction of the liquid crystal display device 10 coincides with the X-axis direction in each figure, a short-side direction of the liquid crystal display device 10 coincides with the Y-axis direction in each figure, and a thickness direction of the liquid crystal display device 10 coincides with the Z-axis direction in each figure. FIG. 2 is a sectional view of the liquid crystal display device 10. As shown in FIG. 2, the liquid crystal display device 10 includes at least a liquid crystal panel (a display panel) 11 that displays an image, a backlight device (an illuminating device) 12 that supplies display light to the liquid crystal panel 11, and a first panel supporting member 13 that is capable of supporting the liquid crystal panel 11 from the front side thereof. FIG. 3 is a plan view of the liquid crystal panel 11, etc. As shown in FIG. 3, the liquid crystal display device 10 includes at least a plurality of flexible substrates 14 that are connected to end portions of the liquid crystal panel 11 and a printed wiring board 15 that is connected to some of the plurality of flexible substrates 14. Note that an ACF (Anisotropic Conductive Film) is interposed in a connection portion at which the liquid crystal panel 11 and the flexible substrates 14 are connected to each other and in a connection portion at which the flexible substrates 14 and the printed wiring board 15 are connected to each other. The liquid crystal panel 11 according to the embodiment is classified as a liquid crystal panel whose resolution regarding a display image is an ultrahigh resolution, such as 4K or 8K.

A structure of the liquid crystal panel 11 is described with reference to FIG. 2. As shown in FIG. 2, the liquid crystal panel 11 is a display surface 11DS whose plate surface on the front side is capable of displaying an image. Of the display surface 11DS, a center-side portion is a display area (an active area) on which an image is to be displayed, and an outer-periphery-side portion is a non-display area (a nonactive area) having a substantially frame shape (a substantially picture-frame shape) in plan view. Note that the Z-axis direction indicated in each figure coincides with a normal direction to the display surface 11DS. The liquid crystal panel 11 includes at least a pair of substrates 11A and 11B that is made of glass, and a liquid crystal layer that is interposed between the pair of substrates 11A and 11B. A polarizing plate 11C is attached to an outer surface of the substrate 11A and a polarizing plate 11D is attached to an outer side of the substrate 11B. Of the polarizing plates 11C and 11D, the polarizing plate 11C that is positioned on the front side is such that its outer surface on the front side constitutes the above-described display surface 11DS. Of the substrates 11A and 11B, the front side (a side of the display surface 11DS or a front-surface side) is defined as a CF substrate (a facing substrate) 11A, and the back side (a side opposite to the side of the display surface 11DS or a back-surface side) is defined as an array substrate (a substrate for the display device, an active matrix substrate, a TFT substrate) 11B. On an inner-surface side of the array substrate 11B, for example, an alignment film is provided in addition to a switching element (for example, a TFT) and pixel electrodes that are disposed in a matrix in a planar arrangement. The switching element is connected to a source wire and a gate wire that are orthogonal to each other, and the pixel electrodes are disposed in a substantially quadrangular-shaped area surrounded by the source wire and the gate wire and are connected to the switching element. On an inner-surface side of the CF substrate 11A, for example, a lattice-shaped light shielding layer (black matrix) and an alignment film are provided in addition to color filters that are provided such that each coloring portion, such as a R (red) portion, a G (green) portion, and a B (blue) portion, is disposed in a predetermined array and in a planar arrangement. The light shielding layer is disposed between the coloring portions. Note that a common electrode that is spaced apart from and superimposed upon the pixel electrodes and that is maintained at a common potential (a reference potential) is provided at either one of the substrates 11A and 11B. In the liquid crystal panel 11, it is possible to cause a predetermined gradation display to be performed by each pixel as a result of subjecting the liquid crystal layer to a predetermined electrical field based on a potential difference that occurs between the common electrode and each pixel electrode.

A structure of the first panel supporting member 13 is described with reference to FIGS. 1 and 2. As shown in FIG. 1, the first panel supporting member 13 has, as a whole, a substantially frame shape that is horizontally long, and extends along an outer peripheral edge of the liquid crystal panel 11. As shown in FIG. 2, the first panel supporting member 13 includes a first panel supporting portion 13A and a first outer frame portion 13B. The first panel supporting portion 13A is disposed so as to face the front side (the side of the display surface 11DS) in the Z-axis direction with respect to an outer edge, which is the non-display area, of the liquid crystal panel 11. The first outer frame portion 13B is disposed so as to protrude toward the back side from an outer edge of the first panel supporting portion 13A and so as to surround, for example, the backlight device 12. The first panel supporting portion 13A is disposed so that a gap C is formed between the first panel supporting portion 13A and the outer edge of the facing liquid crystal panel 11 to thereby make it possible to support the outer edge of the liquid crystal panel 11 from the front side without accidentally pushing the outer edge of the liquid crystal panel 11. The first panel supporting portion 13A is capable of supporting the outer peripheral edge of the liquid crystal panel 11 from the front side over substantially the entire periphery of the outer peripheral edge of the liquid crystal panel 11. The first panel supporting portion 13A is disposed so that a facing surface thereof that faces the outer edge of the liquid crystal panel 11 is parallel to the display surface 11DS. Note that although the position of an inner end of the first panel supporting portion 13A may be disposed slightly closer to the non-display area with respect to the position of a boundary between the display area and the non-display area of the liquid crystal panel 11, the position of the inner end may substantially coincide with the position of the boundary. The first outer frame portion 13B is disposed so as to surround from the outer side, for example, the backlight device 12 over substantially the entire periphery thereof. An inner peripheral surface and an outer peripheral surface of the first outer frame portion 13B are orthogonal to the display surface 11DS.

A structure of the flexible substrates 14 and a structure of the printed wiring board 15 are described with reference to FIGS. 2 and 3. As shown in FIGS. 2 and 3, the flexible substrates 14 are made of a synthetic resin material (such as a polyimide-based resin) and are constituted by forming a plurality of wire patterns on a film-like insulating and flexible base material. The flexible substrates 14 include a plurality of source-side flexible substrates 14A and a plurality of gate-side flexible substrates 14B. The source-side flexible substrates 14A are connected to an outer edge of one of the long sides (the lower side shown in FIG. 3) of the array substrate 11B of the liquid crystal panel 11. The gate-side flexible substrates 14B are connected so that multiple gate-side flexible substrates 14B each are connected to an outer edge of a corresponding one of the short sides of the array substrate 11B. The source-side flexible substrates 14A are subjected to FOG (Film On Glass) mounting from the front side so that multiple source-side flexible substrates 14A (six in the embodiment) are spaced apart from each other and disposed side by side in the X-axis direction with respect to the outer edge of the aforementioned long side of the array substrate 11B. A source driver A1 that supplies an image signal to the source wire that is provided at the array substrate 11B is mounted on a corresponding one of the source-side flexible substrates 14A. The plurality of source-side flexible substrates 14A are connected so that end portions thereof on a side opposite to end portions thereof that are connected to the liquid crystal panel 11 are connected to the printed wiring board 15. The printed wiring board 15 includes a rigid base material having a rigidity that is higher than the rigidity of the flexible substrates 14, and, for example, various electronic components are mounted on a plate surface of the base material. As shown in FIG. 2, the printed wiring board 15 is oriented so that its plate surface is parallel to a side surface of the backlight device 12, and is interposed between the backlight device 12 and the first outer frame portion 13B of the first panel supporting member 13. Therefore, each source-side flexible substrate 14A is bent in a substantially L shape in side view. On the other hand, as shown in FIG. 3, the gate-side flexible substrates 14B are subjected to FOG mounting from the front side so that multiple gate-side flexible substrates 14B each (four each in the embodiment) are spaced apart from each other and disposed side by side in the Y-axis direction with respect to the outer edge of the aforementioned corresponding one of the short sides of the array substrate 11B. A gate driver that supplies a scanning signal to the gate wire that is provided at the array substrate 11B is mounted on a corresponding one of the gate-side flexible substrates 14B. The source drivers 14A1 and the gate drivers are each constituted by an LSI chip having a driving circuit therein. Note that, at the array substrate 11B, the outer edges of the corresponding three sides of the array substrate 11B on which the flexible substrates 14 are mounted are constituted so as to protrude outward with respect to the outer edges of the CF substrate 11A, whereas the outer edge of the long side to which the flexible substrates 14 are not connected is flush with the outer edges of the CF substrate 11A.

A structure of the backlight device 12 is described with reference to FIG. 2. As shown in FIG. 2, the backlight device 12 is a so-called direct backlight device. Specifically, the backlight device 12 includes at least a substantially box-shaped chassis 16 that opens toward the front side, an optical member 17 that is disposed so as to cover the opening of the chassis 16, LEDs (Light Emitting Diodes) 18 that are light sources that are accommodated in the chassis 16, a LED substrate 19 that is a light-source substrate on which the plurality of LEDs 18 are mounted, diffusing lenses 20 that are mounted on the LED substrate 19 and that diffuse light from the LEDs 18, a reflecting sheet 21 that covers an inner surface of the chassis 16, and a second panel supporting member 22 that is capable of supporting the liquid crystal panel 11 from the back side thereof. Since the backlight device 12 according to the embodiment is used in combination with the liquid crystal panel 11 having an ultrahigh resolution, the brightness can be increased. This is because, in the liquid crystal panel 11 having an ultrahigh resolution, the aperture ratio of the pixels is low and thus the brightness regarding a display image tends to be reduced.

The chassis 16 is formed by bending a metal plate material, and, as shown in FIG. 2, includes a bottom portion 16A that has a substantially quadrangular shape that is horizontally long similarly to, for example, the shape of the liquid crystal panel 11, and side portions 16B that extend upward from corresponding outer edges of the bottom portion 16A. Each side portion 16B is bent so that its sectional shape is a substantially U shape. The optical member 17 includes four portions that are stacked upon each other in the Z-axis direction, and these portions are in the order from the back side a diffusing plate 17A, a diffusing sheet 17B, a first lens sheet 17C, and a second lens sheet 17D. The diffusing plate 17A and the diffusing sheet 17B among these portions are constituted by distributing a plurality of diffusing particles for diffusing light in a substantially transparent synthetic resin base material. The first lens sheet 17C and the second lens sheet 17D are constituted by disposing a plurality of unit lenses, which extend in the X-axis direction or the Y-axis direction, side by side in a direction orthogonal to the extension direction of the unit lenses (the Y-axis direction or the X-axis direction) on a plate surface of a substantially transparent synthetic resin base material, and selectively act to concentrate incident light in the direction in which the unit lenses are disposed side by side. The first lens sheet 17C and the second lens sheet 17D are disposed so that the extension directions of their unit lenses are orthogonal to each other.

As shown in FIG. 2, the LEDs 18 are each a so-called top-surface emitting type LED, in which the LEDs 18 are surface-mounted on the LED substrate 19 and light-emitting surfaces thereof face a side opposite to the side of the LED substrate 19. The optical axes of the LEDs 18 extend in the Z-axis direction. Here, “optical axes” refer to axes extending in a direction of propagation of, of emission light at the LEDs 18, light having the highest light emission intensity (light emission intensity peak). The LED substrate 19 is, with its plate surface being oriented parallel the display surface 11DS, accommodated in the chassis 16 and supported from the back side thereof by the bottom portion 16A. The plurality of LEDs 18 are surface-mounted on a portion of the plate surface of the LED substrate 19 that faces the front side, and this portion of the plate surface is a mounting surface. The LEDs 18 are disposed so that, in the plate surface of the LED substrate 19, multiple LEDs 18 each are disposed side by side in a matrix so as to be spaced apart from each other in the X-axis direction and the Y-axis direction. Note that driving power from an external power source (for example, an LED driving substrate) is supplied to the LED substrate 19.

Each diffusing lens 20 is made of a synthetic resin material (for example, polycarbonate or acryl) that is almost transparent (has high transparency) and has a refractive index that is higher than that of air. As shown in FIG. 2, each diffusing lens 20 has a substantially dome shape as a whole, and is mounted on the LED substrate 19 so as to individually cover a light emitting surface of a corresponding one of the LEDs 18 from the front side (light-emitting side), that is, so as to be superimposed upon a corresponding one of the LEDs 18 in plan view. Therefore, the number of diffusing lenses that are set and the planar arrangement of the diffusing lenses in the backlight device 12 are the same as the number of the aforementioned LEDs 18 that are set and the planar arrangement of the aforementioned LEDs 18. The diffusing lenses 20 are capable of, while diffusing light having a high directivity emitted from the LEDs 18, causing such light to exit therefrom. That is, since the directivity of the light emitted from the LEDs 18 is reduced via the diffusing lenses 20, even if the interval between adjacent LEDs 18 is wide, an area existing in the interval is less likely to be seen as a dark portion. Therefore, it is possible to reduce the number of LEDs 18 that are set. The diffusing lenses 20 are disposed substantially concentrically with the LEDs 18 in plan view.

The reflecting sheet 21 is made of a synthetic resin, and has a surface that assumes a white color having excellent light reflectivity. As shown in FIG. 2, since the reflecting sheet 21 has a size that allows it to be laid over substantially the entire area of the inner surface of the chassis 16, the reflecting sheet 21 is capable of covering from the front side substantially the entire area of the LED substrate 19 disposed in the chassis 16. The reflecting sheet 21 is capable of reflecting light in the chassis 16 toward the front side. The reflecting sheet 21 includes a bottom portion 21A that extends along the bottom portion 16A of the chassis 16 and that has a size allowing it to cover a large portion of the bottom portion 16A, four upwardly extending portions 21B that extend upward toward the front side from corresponding outer ends of the bottom portion 21A and that are inclined with respect to the bottom portion 21A, and extending portions 21C that extend outward from outer ends of the corresponding upwardly extending portions 21B and that are placed on the side portions 16B of the chassis 16. The bottom portion 21A of the reflecting sheet 21 is disposed so as to overlap a front-side surface of the LED substrate 19, that is, the mounting surface on which the LEDs 18 are mounted. Holes through which the corresponding diffusing lenses 20 pass open and are formed in corresponding locations in the bottom portion 21A. The extending portions 21C are held between the corresponding side portions 16B of the chassis 16 and an outer edge of the diffusing plate 17A that is disposed closest to the back side in the optical member 17.

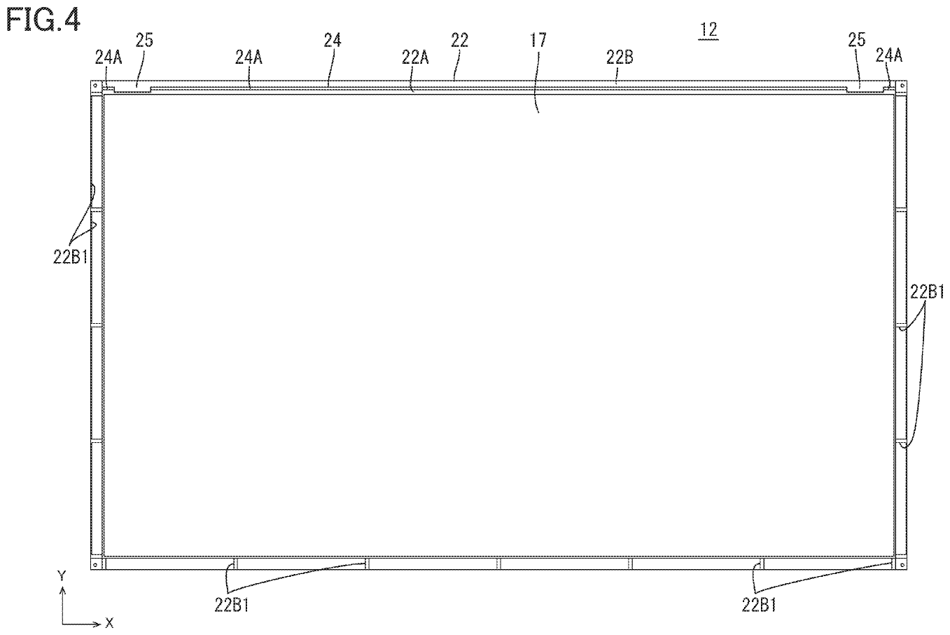

A structure of the second panel supporting member 22 is described with reference to FIGS. 2 and 4. FIG. 4 is a plan view of the backlight device 12. As shown in FIG. 4, the second panel supporting member 22 has, as a whole, a substantially frame shape that is horizontally long, and extends along an outer peripheral edge of the optical member 17 (the liquid crystal panel 11). The second panel supporting member 22 is made of a synthetic resin, and has a surface that assumes a black color having excellent light absorbency. As shown in FIG. 2, the second panel supporting member 22 includes a second panel supporting portion 22A, an interval maintaining portion 22B, and a second outer frame portion 22C. The second panel supporting portion 22A is disposed so as to face the back side (a side opposite to the display surface 11DS) of the outer edge, which is the non-display area, of the liquid crystal panel 11 in the Z-axis direction. The interval maintaining portion 22B is interposed between the first panel supporting portion 13A and the second panel supporting portion 22A and maintains the interval between both of these portions 13A and 22A. The second outer frame portion 22C is disposed so as to protrude toward the back side from an outer edge of the second panel supporting portion 22A and to surround the chassis 16.

As shown in FIG. 2, the second panel supporting portion 22A is disposed so as to be spaced apart from the back side of the first panel supporting portion 13A in the Z-axis direction, and this interval is set larger than the total thickness of the liquid crystal panel 11. Therefore, when the outer edge of the liquid crystal panel 11 is in a state of contact with the second panel supporting portion 22A, the gap C exists between the first panel supporting portion 13A and the outer edge of the liquid crystal panel 11. The second panel supporting portion 22A is capable of supporting the outer peripheral edge of the liquid crystal panel 11 from the back side over substantially the entire periphery of the outer peripheral edge. The second panel supporting portion 22A is disposed so that its facing surface that faces the outer edge of the liquid crystal panel 11 is parallel to the display surface 11DS. A shock absorbing material 23 that is interposed between a front-side surface of the second panel supporting portion 22A and the outer edge of the liquid crystal panel 11 is provided on the front-side surface of the second panel supporting portion 22A. The shock absorbing material is constituted by a foamed resin, such as PORON (tradename), and is a material that assumes a black color having excellent light absorbency. The shock absorbing material 23 has a substantially frame shape so as to extend over the entire periphery of the second panel supporting portion 22A. The shock absorbing material 23 is disposed at, among portions of the second panel supporting portion 22A, an inner-peripheral-side portion including a portion that faces the outer edge of the liquid crystal panel 11. The second panel supporting portion 22A is disposed so as to face the front side of an outer edge of the optical member 17 in the Z-axis direction. The second panel supporting portion 22A is disposed so as to be spaced apart by an interval from the front side of the side portions 16B of the chassis 16 in the Z-axis direction, and this interval is set larger than the total thickness of the thickness of the optical member 17 and the thickness of the reflecting sheet 21. Therefore, when the extending portions 21C of the reflecting sheet 21 are in a state of contact with the side portions 16B of the chassis 16, a gap is formed between the second panel supporting portion 22A and an outer edge of the second lens sheet 17D that is disposed closest to the front side in the optical member 17. Consequently, it is possible to support the outer edge of the optical member 17 from the front side without accidentally pushing the outer edge of the optical member 17. Note that, although the position of an inner end of the second panel supporting portion 22A may be flush with the position of the inner end of the first panel supporting portion 13A, the positions may be slightly displaced from each other.

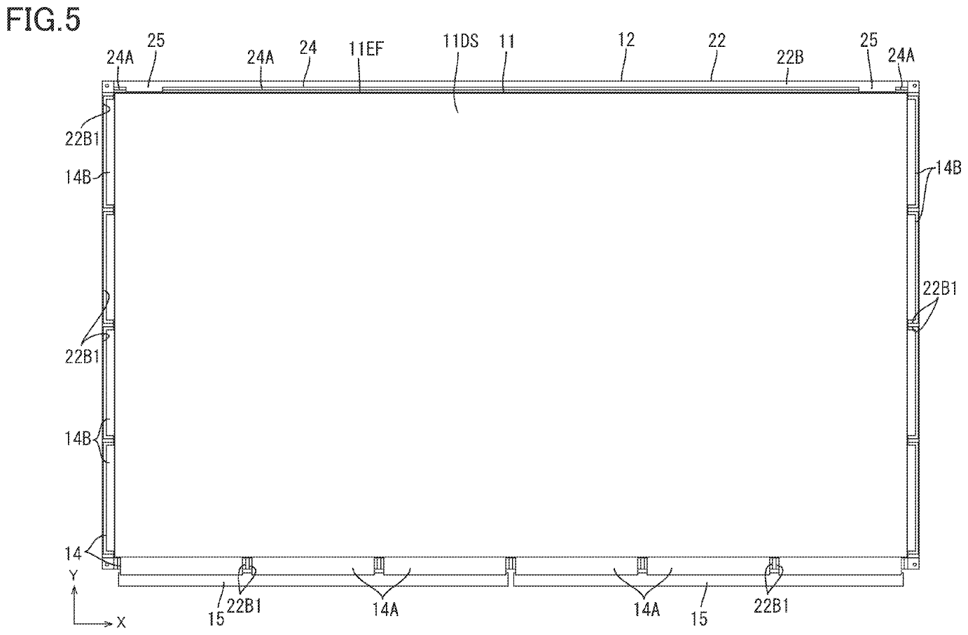

As shown in FIG. 2, the interval maintaining portion 22B protrudes toward the front side from the second panel supporting portion 22A, and its front-side surface is in contact with a back-side surface of the first panel supporting portion 13A. Therefore, it is possible to maintain a certain interval in the Z-axis direction between the first panel supporting portion 13A and the second panel supporting portion 22A. As long as the interval between the first panel supporting portion 13A and the second panel supporting portion 22A is kept substantially constant, the liquid crystal panel 11 is less likely to be accidentally pushed by at least one of the first panel supporting portion 13A and the second panel supporting portion 22A. Therefore, stress is less likely to act upon the liquid crystal panel 11, as a result of which deterioration in the display quality caused by the stress is less likely to occur. As shown in FIG. 4, although the interval maintaining portion 22B is formed in a substantially frame shape along the second panel supporting portion 22A, as shown in FIGS. 2 and 5, insertion recesses 22B1 for passing the corresponding flexible substrates 14 therethrough are provided at positions at which the interval maintaining portion 22B is superimposed upon the flexible substrates 14. FIG. 5 is a plan view of the liquid crystal display device 10 in a state in which the first panel supporting member 13 has been removed. The insertion recesses 22B1 are formed in the interval maintaining portion 22B in a range that is slightly wider than the width of the flexible substrates 14, and the planar arrangement of the insertion recesses 22B1 and the number of insertion recesses 22B1 that are set are in accordance with those of the flexible substrates 14. The second outer frame portion 22C is provided in parallel with the first outer frame portion 13B and is disposed so as to surround from the outer side the side portions 16B of the chassis 16 over substantially the entire periphery of the side portions 16B. An inner peripheral surface and an outer peripheral surface of the second outer frame portion 22C are orthogonal to the display surface 11DS. As shown in FIG. 2, a chassis-side interval maintaining portion 22D that is in contact with front-side surfaces of the side portions 16B of the chassis 16 is provided consecutively with the second panel supporting portion 22A and the second outer frame portion 22C. The chassis-side interval maintaining portion 22D is provided consecutively with an inner surface of a boundary portion of the second outer frame portion 22C and an inner surface of a boundary portion of the second panel supporting portion 22A, and extends over the entire periphery of the second outer frame portion 22C and the second panel supporting portion 22A. By bringing the chassis-side interval maintaining portion 22D into contact with the side portions 16B of the chassis 16, it is possible to maintain a certain interval in the Z-axis direction between the second panel supporting portion 22A and the side portions 16B of the chassis 16. The chassis-side interval maintaining portion 22D is disposed so that its inner surface faces each end surface of the optical member 17 and each end surface of the reflecting sheet 21.

As shown in FIG. 2, the interval maintaining portion 22B of the second panel supporting member 22 is disposed so that its inner surface faces an end surface 11EF of the liquid crystal panel 11. Therefore, when a part of light that is applied to the liquid crystal panel 11 from the backlight device 12 exits from the end surface 11EF of the liquid crystal panel 11, the exiting light strikes the inner surface (facing surface) of the interval maintaining portion 22B. Note that most of the light applied to the liquid crystal panel 11 from the backlight device 12 is used to display an image due to most of the light existing from the display surface 11DS. However, a part of the light that propagates in each of the substrates 11A and 11B and in each of the polarizing plates 11C and 11D at angles that are close to an angular direction along the display surface 11DS and whose incidence angle with respect to the end surface 11EF of the liquid crystal panel 11 does not exceed the critical angle exits from the end surface 11EF. Here, since the second panel supporting member 22 has a surface that assumes a black color having excellent light absorbency, light that has struck the inner surface of the interval maintaining portion 22B is absorbed by a large amount but is partly reflected. When a part of the reflected light leaks to the outside from the gap C between the first panel supporting portion 13A and the outer edge of the liquid crystal panel 11, the display quality may be impaired. The likelihood of light leakage depends upon the picture-frame width of the liquid crystal display device 10. If the picture-frame width is wide, light is less likely to leak, whereas if the picture-frame width is narrow, light is more likely to leak. In the liquid crystal display device 10 according to the embodiment, since the flexible substrates 14 are connected to the outer edges of the three sides among the outer edges of the four sides of the liquid crystal panel 11, the picture-frame widths of the three sides are wide, whereas the picture-frame width of the one side to which the flexible substrates 14 are not connected is narrow. At the side where the picture-frame width is narrow, light leakage caused by the exiting light from the end surface 11EF of the liquid crystal panel 11 is more likely to occur, as a result of which the display quality may be adversely affected. Moreover, in the liquid crystal display device 10 according to the embodiment, since the liquid crystal panel 11 has an ultrahigh resolution and the brightness of the backlight device 12 is increased for dealing with a reduction in the aperture ratio of pixels, the quantity of light that exits from the end surface 11EF of the liquid crystal panel 11 is large and thus the quantity of light leaking from the gap C above tends to increase. In recent years, due to increasing contrast, the screen brightness when a black screen display is performed at the liquid crystal panel 11 is very low. Therefore, even if a slight leakage of light occurs at the side where the picture-frame width is narrow as described above, a problem that the display quality is reduced occurs.

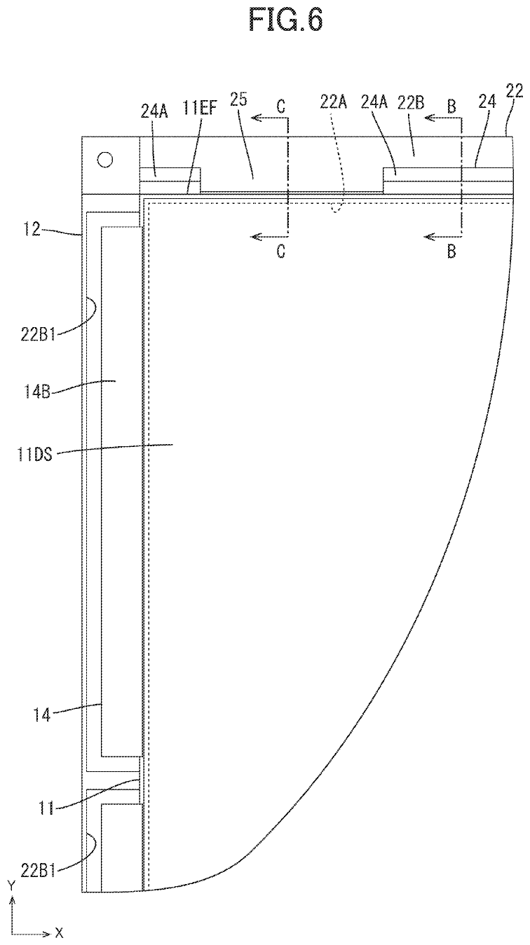

Therefore, as shown in FIGS. 6 and 7, the second panel supporting member 22 according to the embodiment is such that a part of a portion of the interval maintaining portion 22B that faces the end surface 11EF of the liquid crystal panel 11 is a panel-end-surface-facing portion 24 having an inclined surface 24A that is inclined with respect to the Z-axis direction. FIG. 6 is a plan view illustrating in an enlarged form the vicinity of a corner of the liquid crystal display device 10 whose first panel supporting member 13 has been removed. FIG. 7 is a sectional view formed by cutting the vicinity of the panel-end-surface-facing portion 24 of the liquid crystal display device 10. Since the panel-end-surface-facing portion 24 is a part of the interval maintaining portion 22B, the panel-end-surface-facing portion 24 is disposed so as to be interposed between the first panel supporting portion 13A and the second panel supporting portion 22A in the Z-axis direction. The inclined surface 24A is constituted by a substantially entire area of a facing surface of the panel-end-surface-facing portion 24 that faces the end surface 11EF of the liquid crystal panel 11. According to such a structure, when light exits from the end surface 11EF of the liquid crystal panel 11, the light strikes the inclined surface 24A of the panel-end-surface-facing portion 24. When the light that has struck the inclined surface 24A is reflected, the reflected light is angled by an amount corresponding to the inclination of the inclined surface 24A with respect to the Z-axis direction. Compared with reflected light when the facing surface of the panel-end-surface-facing portion that faces the end surface 11EF of the liquid crystal panel 11 is a surface extending in the Z-axis direction, that is, a surface that is orthogonal to the normal direction to the display surface 11DS, the angled reflected light is less likely to reach the gap C that is formed between the liquid crystal panel 11 and the first panel supporting portion 13A. Therefore, leakage of light from the gap C above is reduced, as a result of which it is possible to reduce a reduction in the display quality caused by leaked light. In the embodiment, the panel-end-surface-facing portion 24 having the inclined surface 24A is selectively provided at a facing portion of the substantially frame-shaped interval maintaining portion 22B that faces the outer edge of the one side, to which the flexible substrates 14 are not connected, of the liquid crystal panel 11. Therefore, leakage of light at the portion of the liquid crystal display device 10 at which the picture-frame width is particularly narrow is effectively reduced. Consequently, this is desirable when the contrast is increasing, the resolution is increasing, and the picture frame is being narrowed.

As shown in FIG. 7, as the inclined surface 24A becomes nearer to the front side (the side of the first panel supporting portion 13A) from the back side (the side of the second panel supporting portion 22A) in the Z-axis direction, the inclined surface 24A slopes away from the end surface 11EF of the liquid crystal panel 11. That is, the distance (the interval) between the inclined surface 24A and the end surface 11EF of the liquid crystal panel 11 that face each other is reduced with decreasing distance from the second panel supporting portion 22A in the Z-axis direction, whereas the distance between the inclined surface 24A and the end surface 11EF of the liquid crystal panel 11 that face each other is increased with decreasing distance from the first panel supporting portion 13A in the Z-axis direction. According to such a structure, when light that has exited from the end surface 11EF of the liquid crystal panel 11 is reflected by the inclined surface 24A, the reflected light is angled by the inclined surface 24A and thus propagates toward the back-side surface of the first panel supporting portion 13A (the surface facing the second panel supporting portion 22A). The light reflected by the first panel supporting portion 13A is such that a part thereof propagates toward the front-side surface of the second panel supporting portion 22A (the surface facing the first panel supporting portion 13A) and a part thereof propagates back toward the inclined surface 24A. Therefore, the light that has exited from the end surface 11EF of the liquid crystal panel 11 is to be reflected a multiple number of times by, for example, the inclined surface 24A, the first panel supporting portion 13A, and the second panel supporting portion 22A until the light reaches the gap C that is formed between the liquid crystal panel 11 and the first panel supporting portion 13A, as a result of which leakage of light from the gap C above is further less likely to occur. The inclined surface 24A is provided over the entire area in the Z-axis direction of the facing surface of the panel-end-surface-facing portion 24 that faces the end surface 11EF of the liquid crystal panel 11. The inclined surface 24A is formed so as to extend in a straight line at a substantially constant inclination angle θ1.

Here, the inclined surface 24A is one in which as the inclination angle θ1 changes, there are changes in the quantity of light that leaks from the gap C and in the size of a space in which the panel-end-surface-facing portion 24 is disposed in a width direction (the X-axis direction or the Y-axis direction) at the outer edge of the liquid crystal panel 11. Specifically, when the inclination angle θ1 of the inclined surface 24A with respect to the display surface 11DS is increased, the space in which the panel-end-surface-facing portion 24 is disposed in the width direction is reduced in size, whereas the quantity of light that leaks from the gap C tends to increase. In contrast, when the inclination angle θ1 of the inclined surface 24A with respect to the display surface 11DS is reduced, the quantity of light that leaks from the gap C is reduced, whereas the space in which the panel-end-surface-facing portion 24 is disposed in the width direction tends to increase. The space in which the panel-end-surface-facing portion 24 is disposed in the width direction directly influences the picture-frame width of the liquid crystal display device 10. It is desirable that the inclination angle θ1 of the inclined surface 24A with respect to the display surface 11DS be 60° or less from the viewpoint of reducing the quantity of light that leaks from the gap C and of maintaining the display quality at a high level. If the inclination angle of the inclined surface 24A with respect to the display surface 11DS exceeds 60°, such an inclination angle is desirable from the viewpoint of keeping small the space in which the panel-end-surface-facing portion 24 is disposed in the width direction, but results in a problem in that the display quality is reduced due to an increase in the quantity of light that leaks from the gap C. From the viewpoint of keeping high the display quality, it is desirable that the inclination angle θ1 of the inclined surface 24A with respect to the display surface 11DS be 45° or less. On the other hand, with regard to the space in which the panel-end-surface-facing portion 24 is disposed in the width direction, it is desirable that the inclination angle θ1 be 30° or greater from the viewpoint of keeping small the space in which the panel-end-surface-facing portion 24 is disposed in the width direction. If the inclination angle of the inclined surface 24A with respect to the display surface 11DS is less than 30°, such an angle is desirable from the viewpoint of further reducing the quantity of light that leaks from the gap C, but results in a problem in that the space in which the panel-end-surface-facing portion 24 is disposed in the width direction is too large and thus in a problem in that the picture-frame width is increased by an amount that adversely affects the design of the liquid crystal display device 10. Therefore, it is desirable that the inclination angle θ1 of the inclined surface 24A with respect to the display surface 11DS be in the range of 30° to 60° from the viewpoint of reducing the quantity of light that leaks from the gap C and of keeping narrow the picture-frame width of the liquid crystal display device 10. Among the inclination angles, the inclination angle θ1 of the inclined surface 24A with respect to the display surface 11DS is desirably in the range of 30° to 45° from the viewpoint of further reducing the quantity of light that leaks from the gap C.

As shown in FIG. 6, the interval maintaining portion 22B including the panel-end-surface-facing portion 24 extends along the outer edge of the liquid crystal panel 11 and has varying width in accordance with the position in the extension direction. Specifically, the interval maintaining portion 22B is such that a portion thereof including the panel-end-surface-facing portion 24 has a relatively narrow width, whereas a portion thereof at which the panel-end-surface-facing portion 24 is not disposed is a wide-width portion 25 having a relatively wide width. Therefore, the wide-width portion 25 of the interval maintaining portion 22B has, compared with the other portion (the portion including the panel-end-surface-facing portion 24), the function of maintaining the interval between the first panel supporting portion 13A and the second panel supporting portion 22A by an amount corresponding to the increased width. The panel-end-surface-facing portion 24 having the inclined surface 24A is selectively provided at a position at which the wide-width portion 25 is not disposed in the extension direction of the interval maintaining portion 22B.

As shown in FIG. 7, the portion of the interval maintaining portion 22B including the panel-end-surface-facing portion 24 is disposed such that a back-side end portion of the inclined surface 24A that is situated closest to the end surface 11EF of the liquid crystal panel 11 is spaced apart at a certain interval from the end surface 11EF of the liquid crystal panel 11 and is disposed inward. By utilizing the provided interval, a space in which the shock absorbing material 23 is disposed is ensured on a facing surface (the front-side surface) of the second panel supporting portion 22A that faces the outer edge of the liquid crystal panel 11. On the other hand, as shown in FIG. 8, the wide-width portion 25 of the interval maintaining portion 22B is disposed without being spaced apart from the end surface 11EF of the liquid crystal panel 11. FIG. 8 is a sectional view formed by cutting the vicinity of the wide-width portion 25 of the liquid crystal display device 10. That is, the wide-width portion 25 is such that its surface facing the inner side is in contact with the end surface 11EF of the liquid crystal panel 11. Therefore, by bringing the end surface 11EF of the liquid crystal panel 11 into contact with the wide-width portion 25, it is possible to position the liquid crystal panel 11 in the width direction of the interval maintaining portion 22B. Note that a tapering surface 25A that is chamfered is formed at a portion of the wide-width portion 25 that is adjacent to the first panel supporting portion 13A in the Z-axis direction. According to the tapering surface 25A, when molding the second panel supporting member 22 out of resin, it is possible to smoothly open a forming die in the Z-axis direction. Since the panel-end-surface-facing portion 24 having the inclined surface 24A is selectively provided at a position at which the wide-width portion 25 is not disposed in the extension direction of the interval maintaining portion 22B, it is possible to reduce occurrence of a situation in which if the inclined surface is also provided at the wide-width portion 25, the function of positioning the liquid crystal panel 11 by the wide-width portion 25 may be impaired due to the inclined surface 24A.

As shown in FIG. 6, the wide-width portion 25 is disposed closer to the position of an end than to the position of the center of the interval maintaining portion 22B in the extension direction (the X-axis direction). Specifically, the wide-width portion 25 is disposed near the position of a corner of the substantially frame-shaped interval maintaining portion 22B. More specifically, the wide-width portion 25 is disposed so as to be spaced apart toward a side of the center from the position of the corner of the interval maintaining portion 22B, that is, the position of the end of the interval maintaining portion 22B in the extension direction. Therefore, the panel-end-surface-facing portion 24 having the inclined surface 24A is disposed toward the position of the end and toward the position of the center at the interval maintaining portion 22B in the extension direction with respect to the wide-width portion 25. Although the liquid crystal panel 11 is displaced in the Z-axis direction when the liquid crystal panel 11 is deformed, for example, is warped, the amount of displacement at this time tends to increase with decreasing distance from the position of the end (the position of the corner) of the outer edge in the extension direction. Therefore, the outer edge of the liquid crystal panel 11 is more likely to interfere with the first panel supporting portion 13A with decreasing distance from the position of the end (the position of the corner) in the extension direction. However, since the wide-width portion 25 is disposed closer to the position of the end than to the position of the center of the interval maintaining portion 22B in the extension direction, even if the liquid crystal panel 11 is deformed, for example, is warped, a portion of the outer edge of the liquid crystal panel 11 that is close to the position of the end in the extension direction is less likely to accidentally interfere with the first panel supporting portion 13A. Therefore, stress is less likely to act upon the liquid crystal panel 11, as a result of which deterioration in the display quality caused by the stress is less likely to occur. Moreover, since the wide-width portion 25 has the function of positioning the liquid crystal panel 11 by coming into contact with the end surface 11EF of the liquid crystal panel 11, and is disposed as described above, the liquid crystal panel 11 can be positioned with high precision. On the other hand, since the panel-end-surface-facing portion 24 having the inclined surface 24A is disposed toward the end of the interval maintaining portion 22B in the extension direction with respect to the wide-width portion 25, that is, near the position of the corner, for example, even if protrusions, such as burrs, exist on the end surface 11EF of the liquid crystal panel 11 due to manufacturing reasons, it is possible to cause the protrusions to move into a space provided between the end surface EF of the liquid crystal panel 11 and the inclined surface 24A and to make it less likely for the protrusions to interfere with the panel-end-surface-facing portion 24. Therefore, for example, displacement of the liquid crystal panel 11 in the width direction of the interval maintaining portion 22B caused by the protrusions described above is less likely to occur.

The liquid crystal display device (the display device) 10 of the embodiment described above includes the liquid crystal panel (the display panel) 11 that has the display surface 11DS on which an image is to be displayed, the first panel supporting portion 13A that is disposed so as to face the side of the display surface 11DS in the normal direction to the display surface 11DS with respect to the outer edge of the liquid crystal panel 11 and that is capable of supporting the outer edge, the second panel supporting portion 22A that is disposed so as to face the side opposite to the display surface 11DS in the normal direction with respect to the outer edge and that is capable of supporting the outer edge, and the panel-end-surface-facing portion 24 that is disposed so as to be interposed between the first panel supporting portion 13A and the second panel supporting portion 22A in the normal direction and that is disposed so as to face the end surface 11EF of the liquid crystal panel 11, with at least a part of the facing surface of the panel-end-surface-facing portion 24 being the inclined surface 24A that is inclined with respect to the normal direction, the facing surface facing the end surface 11EF of the liquid crystal panel 11.

Therefore, the outer edge of the liquid crystal panel 11 is capable of being supported by the first panel supporting portion 13A that faces the side of the display surface 11DS in the normal direction to the display surface 11DS and by the second panel supporting portion 22A that faces the side opposite to the display surface 11DS. The panel-end-surface-facing portion 24 is disposed so as to be interposed between the first panel supporting portion 13A and the second panel supporting portion 22A and so as to face the end surface 11EF of the liquid crystal panel 11. Therefore, when light exits from the end surface 11EF of the liquid crystal panel 11, the light may be reflected by the facing surface of the panel-end-surface-facing portion that faces the end surface 11EF of the liquid crystal panel 11 and may leak to the outside from the gap C between the liquid crystal panel 11 and the first panel supporting portion 13A. In this respect, at least a part of the facing surface of the panel-end-surface-facing portion 24 that faces the end surface 11EF of the liquid crystal panel 11 is the inclined surface 24A that is inclined with respect to the normal direction to the display surface 11DS. Therefore, when the light that has exited from the end surface 11EF of the liquid crystal panel 11 is reflected by the inclined surface 24A, the reflected light is angled by an amount corresponding to the inclination of the inclined surface 24A with respect to the normal direction. Thus, by adjusting as appropriate, for example, the inclination of the inclined surface 24A with respect to the normal direction based on, for example, the relationship with the gap C that is formed between the liquid crystal panel 11 and the first panel supporting portion 13A, it is possible to reduce leakage of light from the gap C above. This makes it possible to reduce a reduction in the display quality caused by leaked light, and this is desirable, in particular, when the contrast is increasing, the resolution is increasing, and the picture frame is being narrowed.

The interval maintaining portion 22B that is disposed so as to be interposed between the first panel supporting portion 13A and the second panel supporting portion 22A and that maintains the interval between the first panel supporting portion 13A and the second panel supporting portion 22A in the normal direction may be provided. Therefore, the interval maintaining portion 22B maintains the interval between the first panel supporting portion 13A and the second panel supporting portion 22A, as a result of which the liquid crystal panel 11 is less likely to be accidentally pushed by at least one of the first panel supporting portion 13A and the second panel supporting portion 22A. Thus, stress is less likely to act upon the liquid crystal panel 11, as a result of which deterioration in the display quality caused by the stress is less likely to occur.

The panel-end-surface-facing portion 24 may be integrated with the interval maintaining portion 22B. Therefore, a portion of the interval maintaining portion 22B that faces the end surface 11EF of the liquid crystal panel 11 constitutes the panel-end-surface-facing portion 24. Compared with when the panel-end-surface-facing portion is formed as a separate component from the interval maintaining portion 22B, it is possible to, for example, reduce the number of assembly man hours during manufacturing.

The first panel supporting portion 13A, the second panel supporting portion 22A, and the interval maintaining portion 22B may extend along the outer edge of the liquid crystal panel 11, and the interval maintaining portion 22B may include the wide-width portion 25 partly having a wide width. Therefore, the wide-width portion 25 of the interval maintaining portion 22B has, compared with the other portion, the function of maintaining the interval between the first panel supporting portion 13A and the second panel supporting portion 22A by an amount corresponding to the increased width.

The wide-width portion 25 may be disposed closer to the position of the end than to the position of the center of the interval maintaining portion 22B in the extension direction. Although the liquid crystal panel 11 is displaced in the normal direction to the display surface 11DS when the liquid crystal panel 11 is deformed, for example, is warped, the amount of displacement at this time tends to increase with decreasing distance from the position of an end of the outer edge in the extension direction. Therefore, the outer edge of the liquid crystal panel 11 is more likely to interfere with the first panel supporting portion 13A with decreasing distance from the position of the end in the extension direction. However, since the wide-width portion 25 is disposed closer to the position of the end than to the position of the center of the interval maintaining portion 22B in the extension direction, even if the liquid crystal panel 11 is deformed, for example, is warped, a portion of the outer edge of the liquid crystal panel 11 that is close to the position of the end in the extension direction is less likely to accidentally interfere with the first panel supporting portion 13A. Therefore, stress is less likely to act upon the liquid crystal panel 11, as a result of which deterioration in the display quality caused by the stress is less likely to occur.

The panel-end-surface-facing portion 24 having the inclined surface 24A may be selectively provided at a position at which the wide-width portion 25 is not disposed in the extension direction of the interval maintaining portion 22B, and the wide-width portion 25 may be in contact with the end surface 11EF of the liquid crystal panel 11. Therefore, by causing the end surface 11EF of the liquid crystal panel 11 to come into contact with the wide-width portion 25, the liquid crystal panel 11 is positioned in the width direction of the interval maintaining portion 22B. In particular, since the wide-width portion 25 is disposed closer to the position of the end than to the position of the center of the interval maintaining portion 22B in the extension direction, the liquid crystal panel 11 can be positioned with high precision. Since the panel-end-surface-facing portion 24 having the inclined surface 24A is selectively provided at a position at which the wide-width portion 25 is not disposed in the extension direction of the interval maintaining portion 22B, it is possible to reduce occurrence of a situation in which if the inclined surface is also provided at the wide-width portion 25, the function of positioning the liquid crystal panel 11 by the wide-width portion 25 may be impaired due to the inclined surface 24A.

The wide-width portion 25 may be disposed so as to be spaced apart toward the center from the position of the end of the interval maintaining portion 22B, and the panel-end-surface-facing portion 24 having the inclined surface 24A may be disposed so as to be spaced apart from the end surface 11EF of the liquid crystal panel 11. Therefore, the panel-end-surface-facing portion 24 is provided at the position of the end of the interval maintaining portion 22B in the extension direction, and the inclined surface 24A thereof and the end surface 11EF of the liquid crystal panel 11 are spaced apart from each other. Thus, for example, even if protrusions, such as burrs, exist on the end surface 11EF of the liquid crystal panel 11 due to manufacturing reasons, it is possible to make it less likely for the protrusions to interfere with the panel-end-surface-facing portion 24. Therefore, for example, displacement of the liquid crystal panel 11 in the width direction of the interval maintaining portion 22B caused by the protrusions above is less likely to occur.

The gradient of the inclined surface 24A may be set so that the inclined surface 24A slopes away from the end surface 11EF of the liquid crystal panel 11 as the panel-end-surface-facing portion 24 becomes nearer to the side of the first panel supporting portion 13A from the side of the second panel supporting portion 22A in the normal direction. Therefore, when light that has exited from the end surface 11EF of the liquid crystal panel 11 is reflected by the inclined surface 24A, the reflected light is angled by the inclined surface 24A and thus propagates toward the first panel supporting portion 13A. The light reflected by the first panel supporting portion 13A is such that a part thereof propagates toward the second panel supporting portion 22A and a part thereof propagates back toward the inclined surface 24A. Therefore, the light that has exited from the end surface 11EF of the liquid crystal panel 11 is to be reflected a multiple number of times by, for example, the inclined surface 24A, the first panel supporting portion 13A, and the second panel supporting portion 22A until the light reaches the gap C that is formed between the liquid crystal panel 11 and the first panel supporting portion 13A, as a result of which leakage of light from the gap C above is further less likely to occur.

The display device may include the backlight device (the illuminating device) 12 that is disposed on the side opposite to the display surface 11DS in the normal direction to the liquid crystal panel 11 and that illuminates the liquid crystal panel 11 with display light. Therefore, by utilizing the light emitted from the backlight device 12, an image is displayed on the display surface 11DS of the liquid crystal panel 11. All of the light from the backlight device 12 that illuminates the liquid crystal panel 11 may not be used for the display, that is, a part of the light may exit from the end surface 11EF of the liquid crystal panel 11. In particular, when the efficiency with which the light is used by the liquid crystal panel 11 is reduced due to increasing resolution of the liquid crystal panel 11, there tends to be a demand for a larger quantity of illumination light from the backlight device 12, in which case, the quantity of light that exits from the end surface 11EF of the liquid crystal panel 11 tends to increase. In this respect, since, due to the inclined surface 24A of the panel-end-surface-facing portion 24, the light that has exited from the end surface 11EF of the liquid crystal panel 11 is less likely to reach the gap C that is formed between the liquid crystal panel 11 and the first panel supporting portion 13A, even if the brightness of the backlight device 12 is being increased due to increasing resolution of the liquid crystal panel 11, leakage of light is less likely to occur.

### Second Embodiment

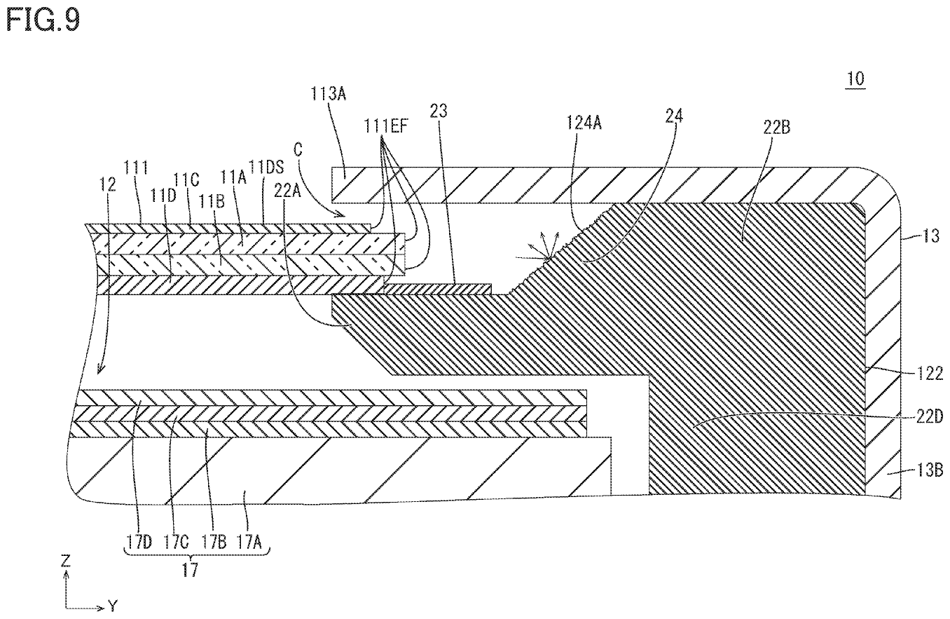

A second embodiment is described with reference to FIG. 9. In the second embodiment, an inclined surface 124A having a different structure is described. Note that structures, operations, and effects that are the same as those of the first embodiment above are not described below.

The inclined surface 124A according to the embodiment may be roughened. Specifically, the inclined surface 124A of a second panel supporting member 122 is a surface subjected to an emboss processing operation. The emboss processing operation may be a physical processing operation, such as sandblasting, or a chemical processing operation, such as etching. The inclined surface 124A of the second panel supporting member 122 is roughened over substantially the entire region thereof, whereas the other portions are not roughened. According to such a structure, light that has exited from an end surface 111EF of a liquid crystal panel 111 and that has reached the inclined surface 124A is scattered by the roughened inclined surface 124A. Therefore, compared with when the inclined surface is a mirror surface, light reflected by the inclined surface 124A is less likely to reach a gap C that is formed between the liquid crystal panel 111 and a first panel supporting portion 113A, as a result of which it is possible to reduce leakage of light from the gap C above.

According to the embodiment described above, the inclined surface 124A may be roughened. Therefore, light that has exited from the end surface 111EF of the liquid crystal panel 111 and that has reached the inclined surface 124A is scatted by the roughened inclined surface 124A. Therefore, the light reflected by the inclined surface 124A is less likely to reach the gap C that is formed between the liquid crystal panel 111 and the first panel supporting portion 113A, as a result of which it is possible to reduce leakage of light from the gap C above.

### Third Embodiment

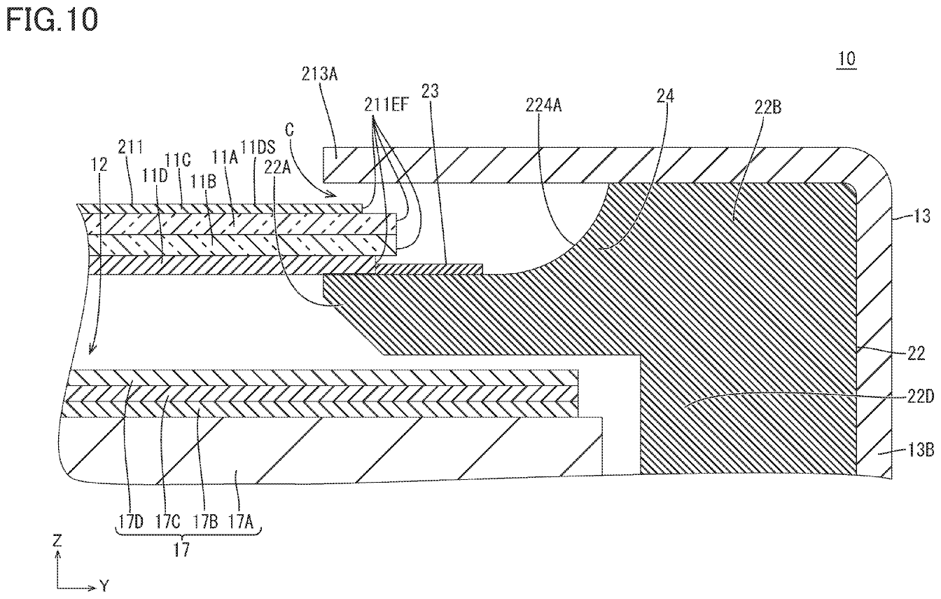

A third embodiment is described with reference to FIG. 10. In the third embodiment, an inclined surface 224A having a structure that differs from that of the first embodiment above is described. Note that structures, operations, and effects that are the same as those of the first embodiment above are not described below.

As shown in FIG. 10, the inclined surface 224A according to the embodiment has an arc shape in cross section. The arc-shaped inclined surface 224A is formed so that its curvature center is positioned on the front side with respect to the inclined surface 224A. Therefore, the inclined surface 224A is a curved surface that is withdrawn from an end surface 211EF of a liquid crystal panel 211 with respect to an imaginary line connecting the position of a base end and the position of a terminal end of the inclined surface 224A. The curvature radius of the inclined surface 224A is set larger than half of the total thickness of the liquid crystal panel 211. The inclined surface 224A is such that almost all tangential lines with respect to any point on a peripheral surface thereof are inclined with respect to the Z-axis direction. According to such a structure, light reflected by the inclined surface 224A is less likely to reach a gap C that is formed between the liquid crystal panel 211 and a first panel supporting portion 213A, and leakage of light is less likely to occur. Moreover, by setting the curvature of the inclined surface 224A as described above, leakage of light is further less likely to occur.

### Fourth Embodiment

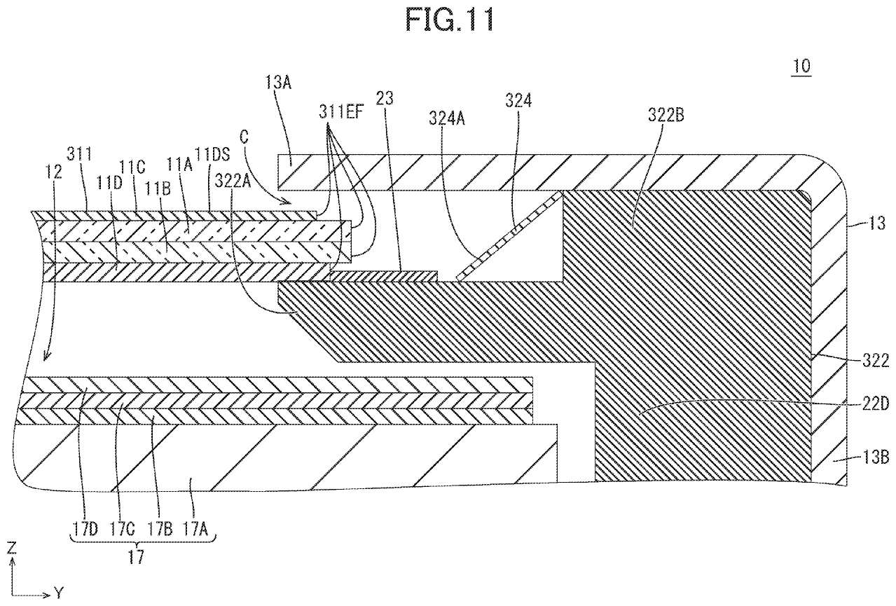

A fourth embodiment is described with reference to FIG. 11. In the fourth embodiment, a panel-end-surface-facing portion 324 having a structure that differs from that of the first embodiment above is described. Note that structures, operations, and effects that are the same as those of the first embodiment above are not described below.

As shown in FIG. 11, the panel-end-surface-facing portion 324 according to the embodiment is formed as a separate component from a second panel supporting member 322. Specifically, the panel-end-surface-facing portion 324 is constituted by an adhesive tape whose surface assumes a black color. The panel-end-surface-facing portion 324 extends so as to be inclined with respect to the Z-axis direction and has two end portions in an extension direction, one of the two ends being attached to a second panel supporting portion 322A and the other of the two ends being attached to an interval maintaining portion 322B. The panel-end-surface-facing portion 324 that is mounted in this way may be disposed so as to be adjacent to a side of an end surface 311EF of a liquid crystal panel 311 with respect to the interval maintaining portion 322B. A surface of the panel-end-surface-facing portion 324 that faces the end surface 311EF of the liquid crystal panel 311 is an inclined surface 324A. According to such a structure, for example, when an interval maintaining portion 322B that does not include a panel-end-surface-facing portion 324 exists as an existing component, the effect of reducing leakage of light can be realized by mounting the panel-end-surface-facing portion 324 onto the interval maintaining portion 322B, which is an existing component. Therefore, since this makes it possible to use an existing component as the interval maintaining portion 322B, this is desirable for manufacturing reasons.

According to the embodiment described above, the panel-end-surface-facing portion 324 may be disposed so as to be adjacent to the side of the end surface 311EF of the liquid crystal panel 311 with respect to the interval maintaining portion 322B, and may be mounted on, at least, the interval maintaining portion 322B. Therefore, for example, when an interval maintaining portion 322B that does not include a panel-end-surface-facing portion 324 having an inclined surface 324A exists as an existing component, the effect of reducing leakage of light can be realized by mounting the panel-end-surface-facing portion 324 onto the interval maintaining portion 322B, which is an existing component. Therefore, since this makes it possible to use an existing component as the interval maintaining portion 322B, this is desirable for manufacturing reasons.

### Fifth Embodiment

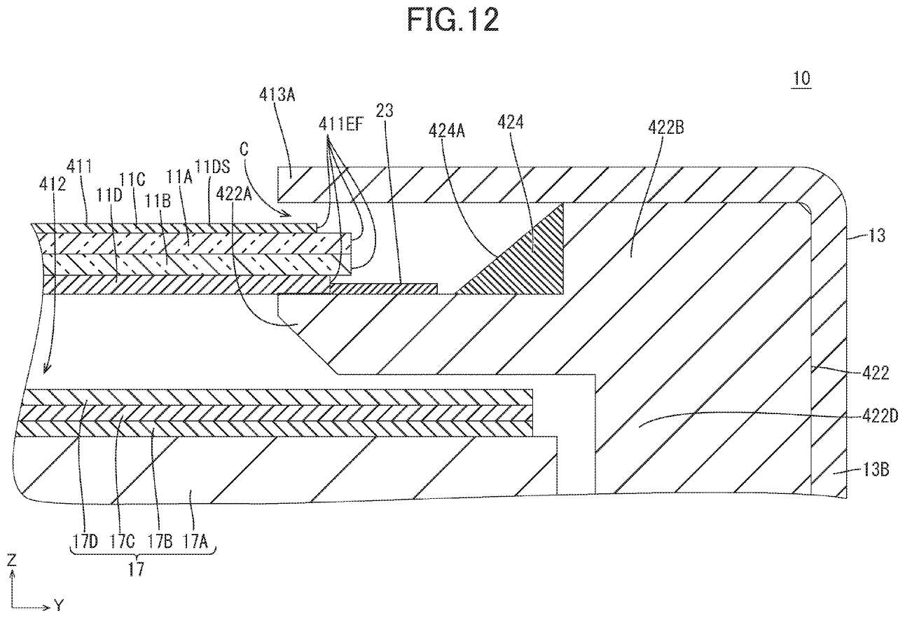

A fifth embodiment is described with reference to FIG. 12. In the fifth embodiment, a panel-end-surface-facing portion 424 having a structure that differs from that of the fourth embodiment above is described. Note that structures, operations, and effects that are the same as those of the fourth embodiment above are not described below.

As shown in FIG. 12, the panel-end-surface-facing portion 424 is formed as a separate component from a second panel supporting member 422, and is made of a synthetic resin whose surface color differs from that of the second panel supporting member 422. Specifically, the panel-end-surface-facing portion 424 has a substantially right-angled triangular shape in cross section, with an inclined side thereof constituting an inclined surface 424A and the remaining two sides being mounted in contact with a corresponding one of a second panel supporting portion 422A and an interval maintaining portion 422B. Since the panel-end-surface-facing portion 424 has a surface that assumes a black color having excellent light absorbency, when light that has exited from an end surface 411EF of a liquid crystal panel 411 has struck the inclined surface 424A, a large quantity of light can be absorbed. In contrast, the second panel supporting member 422 has a surface that assumes a white color having excellent light reflectivity. That is, the second panel supporting member 422 has a light absorbance that is lower than that of the panel-end-surface-facing portion 424 and a light reflectance that is higher than that of the panel-end-surface-facing portion 424. The second panel supporting portion 422A and a chassis-side interval maintaining portion 422D that constitute the second panel supporting member 422 each have an inner surface that faces optical components (such as an optical member 417) that constitute a backlight device 412. Therefore, it is possible to increase the efficiency with which the backlight device 412 uses light as a result of the facing surfaces efficiently reflecting the light.

According to the embodiment described above, the second panel supporting portion 422A may be integrated with the interval maintaining portion 422B and may have a light absorbance that is lower than that of the panel-end-surface-facing portion 424 and a light reflectance that is higher than that of the panel-end-surface-facing portion 424. Therefore, compared with when the light absorbance and the light reflectance of each of the second panel supporting portion and the interval maintaining portion are about the same as the light absorbance and the light reflectance of the panel-end-surface-facing portion 424, light is less likely to be absorbed and is more likely to be reflected by the second panel supporting portion 422A and the interval maintaining portion 422B, as a result of which it is possible to increase the efficiency with which the light is used. In addition, compared with when a first panel supporting portion is integrated with the interval maintaining portion 422B, it is possible to more freely constitute the first panel supporting portion 413A.

### Sixth Embodiment

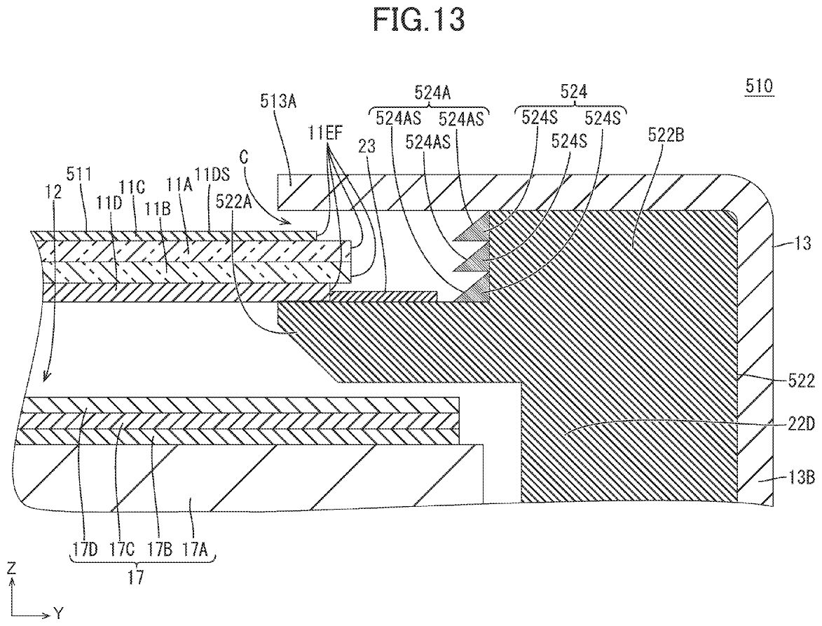

A sixth embodiment is described with reference to FIG. 13. In the sixth embodiment, a panel-end-surface-facing portion 524 having a structure that differs from that of the fifth embodiment above is described. Note that structures, operations, and effects that are the same as those of the fifth embodiment above are not described below.

As shown in FIG. 13, the panel-end-surface-facing portion 524 according to the embodiment may include three split panel-end-surface-facing portions 524S that are disposed so as to overlap each other in the Z-axis direction. Since the panel-end-surface-facing portion 524 has a split structure, an inclined surface 524A may include three split inclined surfaces 524AS of the three respective split panel-end-surface-facing portions 524S. The three split panel-end-surface-facing portions 524S each have a substantially right-angled triangular shape in cross section, and an inclined side of each split panel-end-surface-facing portion 524S constitutes a corresponding one of the split inclined surfaces 524AS. The three split inclined surfaces 524AS are each inclined with respect to the Z-axis direction, and their gradients are substantially the same as that of the inclined surface 424A described in the fifth embodiment above. The three split panel-end-surface-facing portions 524S are disposed side by side in a straight line in the Z-axis direction, with a side of each split panel-end-surface-facing portion 524S facing an interval maintaining portion 522B being mounted on the interval maintaining portion 522B. A side of the backmost split panel-end-surface-facing portion 524S that faces the back side is mounted on a second panel supporting portion 522A. The three split panel-end-surface-facing portions 524S are such that the total sum of the lengths of their sides that face a side of the interval maintaining portion 522B is substantially the same as the length of the corresponding side of the panel-end-surface-facing portion 424 (see FIG. 12) described in the fifth embodiment above. In contrast, the length of a side of each split panel-end-surface-facing portion 524S that faces the back side is about ⅓ of the length of the corresponding side of the panel-end-surface-facing portion 424 described in the fifth embodiment above. Therefore, compared with when the inclined surface 424A is constituted by one continuous surface as with the panel-end-surface-facing portion 424 described in the fifth embodiment above, the panel-end-surface-facing portion 524 according to the embodiment is such that a space in which the panel-end-surface-facing portion 524 is disposed in the width direction (the Y-axis direction) of an outer edge of a liquid crystal panel 511 can be reduced in size. This is desirable from the viewpoint of narrowing a picture frame of a liquid crystal display device 510. Note that each split panel-end-surface-facing portion 524S and a second panel supporting member 522 have a surface that assumes a black color having excellent light absorbency.

According to the embodiment described above, the panel-end-surface-facing portion 524 may include the plurality of split panel-end-surface-facing portions 524S that are disposed so as to overlap each other in the normal direction, and the inclined surface 524A may include the split inclined surfaces 524AS of the respective split panel-end-surface-facing portions 524S. Therefore, compared with when the panel-end-surface-facing portion is a single panel-end-surface-facing portion and the inclined surface is one continuous surface, the space in which the panel-end-surface-facing portion 524 is disposed in the width direction of the outer edge of the liquid crystal panel 511 can be reduced in size. This is desirable from the viewpoint of narrowing the picture frame of the liquid crystal display device 510.

### Seventh Embodiment

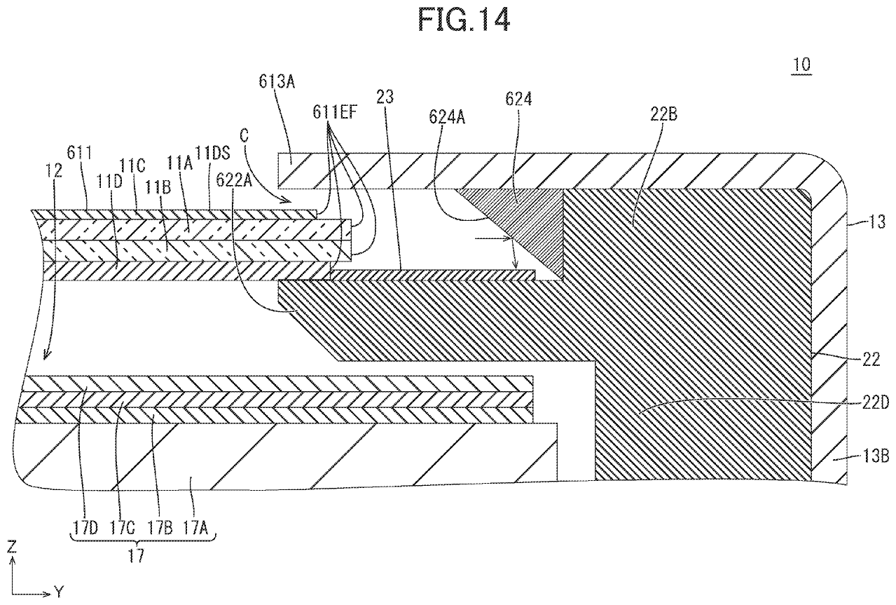

A seventh embodiment is described with reference to FIG. 14. In the seventh embodiment, a panel-end-surface-facing portion 624 having a structure that differs from that of the fifth embodiment above is described. Note that structures, operations, and effects that are the same as those of the fifth embodiment above are not described below.

As shown in FIG. 14, the gradient of an inclined surface 624A may be set so that the inclined surface 624A slopes toward an end surface 611EF of a liquid crystal panel 611 as the panel-end-surface-facing portion 624 according to the embodiment becomes nearer to the front side (a side of a first panel supporting portion 613A) from the back side (a side of a second panel supporting portion 622A) in the Z-axis direction. That is, the distance (the interval) between the inclined surface 624A and the end surface 611EF of the liquid crystal panel 611 that face each other is increased with decreasing distance from the second panel supporting portion 622A in the Z-axis direction, whereas the distance between the inclined surface 624A and the end surface 611EF of the liquid crystal panel 611 that face each other is decreased with decreasing distance from the first panel supporting portion 613A in the Z-axis direction. According to such a structure, when light that has exited from the end surface 611EF of the liquid crystal panel 611 is reflected by the inclined surface 624A, the reflected light is angled by the inclined surface 624A and thus propagates toward a front-side surface of the second panel supporting portion 622A (a surface facing the first panel supporting portion 613A). Therefore, the light that has exited from the end surface 611EF of the liquid crystal panel 611 is to be reflected a multiple number of times by at least the inclined surface 624A and the second panel supporting portion 622A until the light reaches a gap C that is formed between the liquid crystal panel 611 and the first panel supporting portion 613A, as a result of which leakage of light from the gap C above is further less likely to occur.

According to the embodiment described above, the gradient of the inclined surface 624A may be set so that the inclined surface 624A slopes toward the end surface 611EF of the liquid crystal panel 611 as the panel-end-surface-facing portion 624 becomes nearer to the side of the first panel supporting portion 613A from the side of the second panel supporting portion 622A in the normal direction. Therefore, when light that has exited from the end surface 611EF of the liquid crystal panel 611 is reflected by the inclined surface 624A, the reflected light is angled by the inclined surface 624A and thus propagates toward the second panel supporting portion 622A. Therefore, the light that has exited from the end surface 611EF of the liquid crystal panel 611 is to be reflected by at least the inclined surface 624A and the second panel supporting portion 622A until the light reaches the gap C that is formed between the liquid crystal panel 611 and the second panel supporting portion 622A, as a result of which leakage of light from the gap C above is less likely to occur.

### Eighth Embodiment

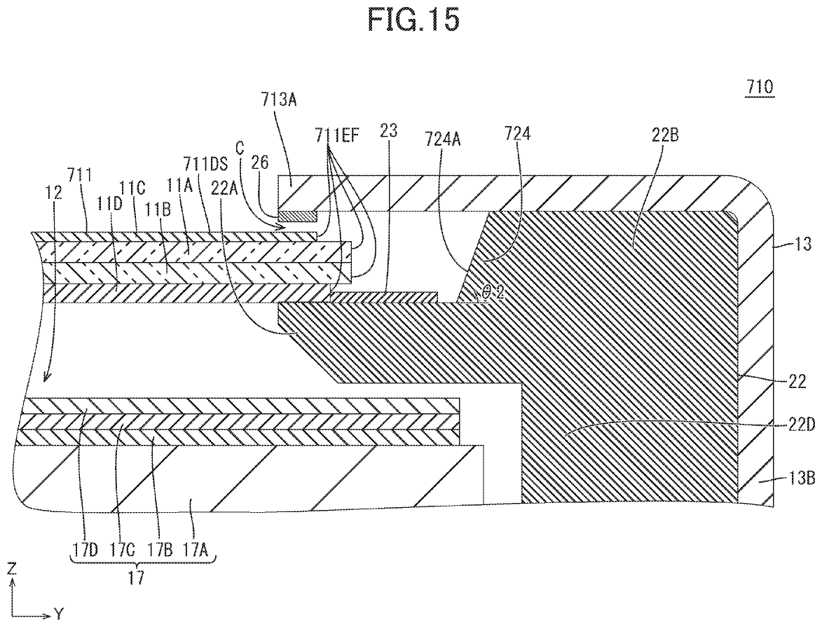

An eighth embodiment is described with reference to FIG. 15. In the eighth embodiment, for example, an inclination angle θ2 that differs from the inclination angle of the first embodiment above is described. Note that structures, operations, and effects that are the same as those of the first embodiment above are not described below.

As shown in FIG. 15, a panel-end-surface-facing portion 724 according to the embodiment is such that the inclination angle θ2 of an inclined surface 724A is 60° or greater. Specifically, in the embodiment, the inclination angle θ2 of the inclined surface 724A is in the range of 60° to 80°. According to such a structure, a space in which the panel-end-surface-facing portion 724 is disposed in the width direction at an outer edge of a liquid crystal panel 711 can be reduced in size, whereas the quantity of light that reaches a gap C may be increased. Therefore, a light absorbing portion 26 having a light absorbance that is higher than that of a first panel supporting portion 713A is provided on a facing surface of the first panel supporting portion 713A that faces the outer edge of the liquid crystal panel 711. Since the light absorbing portion 26 is made of a synthetic resin material and has a surface that assumes a black color having excellent light absorbency, its light absorbance is higher than the light absorbance of the first panel supporting portion 713A that is made of a metal-plate material. According to such a structure, even if a large quantity of light reaches the gap C due to the inclination angle θ2 of the inclined surface 724A being large, it is possible to efficiently absorb the light by the light absorbing portion 26. This is desirable from the viewpoint of reducing leakage of light and narrowing a picture frame of a liquid crystal display device 710.

According to the embodiment described above, the light absorbing portion 26 having a light absorbance that is higher than the light absorbance of the first panel supporting portion 713A may be provided on at least one of the facing surface of the first panel supporting portion 713A that faces the liquid crystal panel 711 and a facing surface of the liquid crystal panel 711 that faces the first panel supporting portion 713A. Therefore, even if light that has exited from an end surface 711EF of the liquid crystal panel 711 reaches the gap C that is formed between the liquid crystal panel 711 and the first panel supporting portion 713A, the light absorbing portion 26 absorbs the light to make it less likely for the light to leak to the outside. Here, as the angle of the inclined surface 724A with respect to a normal direction to a display surface 711DS increases, the quantity of light that reaches the gap C above tends to increase, whereas the space in which the panel-end-surface-facing portion 724 is disposed in the width direction at the outer edge of the liquid crystal panel 711 tends to be reduced in size. Therefore, when the light absorbing portion 26 is caused to absorb the light that has reached the gap C above, even if the angle of the inclined surface 724A with respect to the normal direction to the display surface 711DS is large, leakage of light is less likely to occur. That is, providing the light absorbing portion 26 is desirable from the viewpoints of reducing leakage of light and narrowing the picture frame of the liquid crystal display device 710.

### Ninth Embodiment

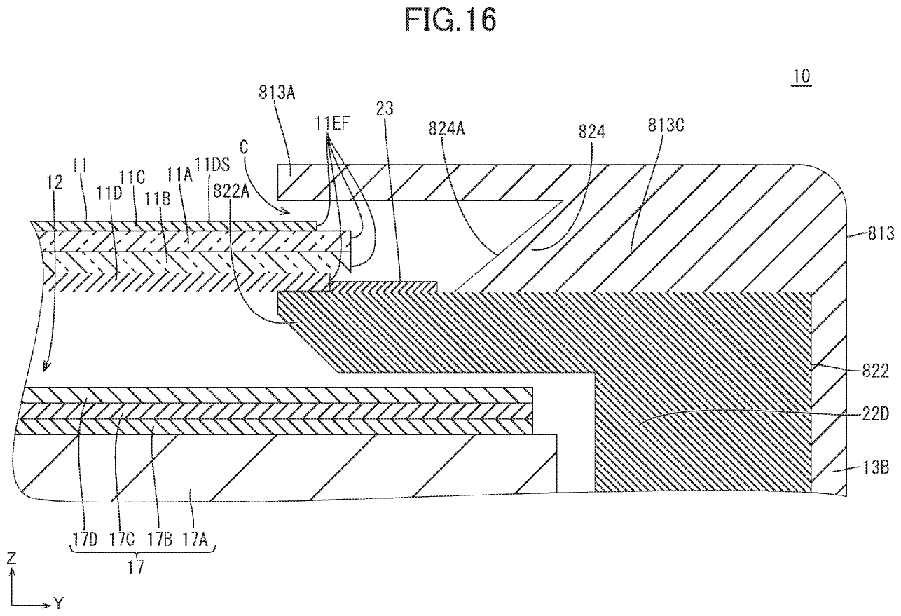

A ninth embodiment is described with reference to FIG. 16. In the ninth embodiment, an interval maintaining portion 813C having a structure that differs from the first embodiment above is described. Note that structures, operations, and effects that are the same as those of the first embodiment above are not described below.

A first panel supporting member 813 according to the embodiment is made of a synthetic resin, and, as shown in FIG. 16, includes the interval maintaining portion 813C that is disposed so as to be interposed between a first panel supporting portion 813A and a second panel supporting portion 822A and that maintains an interval between both of the supporting portions 813A and 822A. The interval maintaining portion 813C is formed so as to protrude toward the back side from the first panel supporting portion 813A. A back-side surface of the interval maintaining portion 813C is in contact with a front-side surface of the second panel supporting portion 822A. Therefore, it is possible to maintain a certain interval in the Z-axis direction between the first panel supporting portion 813A and the second panel supporting portion 822A. The interval maintaining portion 813C is integrated with a panel-end-surface-facing portion 824 having an inclined surface 824A. Note that the interval maintaining portion 813C and the panel-end-surface-facing portion 824 are not formed at a second panel supporting member 822 according to the embodiment.

### Tenth Embodiment

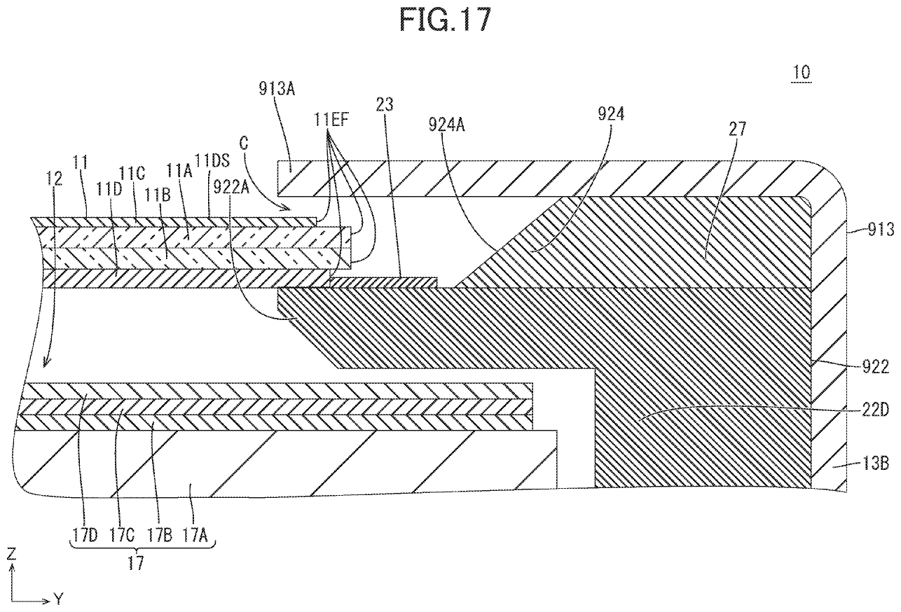

A tenth embodiment is described with reference to FIG. 17. In the tenth embodiment, an interval maintaining portion 27 having a structure that differs from that of the first embodiment above is described. Note that structures, operations, and effects that are the same as those of the first embodiment above are not described below.

As shown in FIG. 17, the interval maintaining portion 27 according to the embodiment is a separate component from a first panel supporting member 913 and a second panel supporting member 922. The interval maintaining portion 27 is made of a synthetic resin, is interposed between a first panel supporting portion 913A and a second panel supporting portion 922A, and is capable of maintaining an interval between both supporting portions 913A and 922A. Therefore, it is possible to maintain a certain interval in the Z-axis direction between the first panel supporting portion 913A and the second panel supporting portion 922A. The interval maintaining portion 27 is integrated with a panel-end-surface-facing portion 924 having an inclined surface 924A. Note that the interval maintaining portion 27 and the panel-end-surface-facing portion 924 are not formed at the second panel supporting member 922 according to the embodiment.

### OTHER EMBODIMENTS

The technology that the specification discloses is not limited to the embodiments described in the descriptions above and with reference to the drawings above, and, thus, for example, the following embodiments are included in the technical range.

(1) The wide-width portions 25 may be disposed at different locations as appropriate in the direction of extension (peripheral direction) of a corresponding one of the interval maintaining portions 22B, 322B, 422B, and 522B. For example, the wide-width portions 25 may be disposed at the position of an end (the position of a corner) or the position of the center of the corresponding one of the interval maintaining portions 22B, 322B, 422B, and 522B in the extension direction thereof. The wide-width portions 25 may be disposed closer to the position of the center than to the position of the end of the corresponding one of the interval maintaining portions 22B, 322B, 422B, and 522B in the extension direction thereof. In addition, a specific formation range at each wide-width portion 25 in the extension direction above can be changed as appropriate. Further, the specific number of wide-width portions 25 that is set can be changed as appropriate.

(2) The wide-width portions 25 may each be out of contact with a corresponding one of the end surface 11EF of the liquid crystal panel 11, the end surface 111EF of the liquid crystal panel 111, the end surface 211EF of the liquid crystal panel 211, the end surface 311EF of the liquid crystal panel 311, the end surface 411EF of the liquid crystal panel 411, the end surface 11EF of the liquid crystal panel 511, the end surface 611EF of the liquid crystal panel 611, and the end surface 711EF of the liquid crystal panel 711. That is, the wide-width portions 25 may be such as not to have the function of positioning a corresponding one of the liquid crystal panels 11, 111, 211, 311, 411, 511, 611, and 711.

(3) The panel-end-surface-facing portions 24, 324, 424, 524, 624, 724, 824, and 924 may each be such that a part of the facing surface that faces a corresponding one of the end surface 11EF of the liquid crystal panel 11, the end surface 111EF of the liquid crystal panel 111, the end surface 211EF of the liquid crystal panel 211, the end surface 311EF of the liquid crystal panel 311, the end surface 411EF of the liquid crystal panel 411, the end surface 11EF of the liquid crystal panel 511, the end surface 611EF of the liquid crystal panel 611, and the end surface 711EF of the liquid crystal panel 711 is a corresponding one of the inclined surfaces 24A, 124A, 224A, 324A, 424A, 524A, 624A, 724A, 824A, and 924A, and such that the remaining part thereof is a non-inclined surface (for example, a surface that is parallel to the Z-axis direction).

(4) In a modification of the second embodiment above, only a part of the inclined surface 124A may be roughened.

(5) In a modification of the third embodiment, the arc-shaped inclined surface 224A may constituted so that its curvature center is positioned on the back side with respect to the inclined surface 224A. The inclined surface 224A may be constituted by a curved surface other than an arc-shaped surface.

(6) In a modification of the third embodiment, the curvature radius of the inclined surface 224A may be set smaller than half of the total thickness of the liquid crystal panel 211.

(7) In modifications of the fourth to the seventh embodiments above, the panel-end-surface-facing portions 324, 424, 524, and 624 may each be exclusively mounted on a corresponding one of the interval maintaining portions 322B, 422B, and 522B without being mounted on a corresponding one of the first panel supporting portions 413A, 513A, and 613A or a corresponding one of the second panel supporting portions 322A, 422A, 522A, and 622A. In contrast, the panel-end-surface-facing portions 324, 424, 524, and 624 may each be exclusively mounted on a corresponding one of the first panel supporting portions 413A, 513A, and 613A or a corresponding one of the second panel supporting portions 322A, 422A, 522A, and 622A without being mounted on a corresponding one of the interval maintaining portions 322B, 422B, and 522B.

(8) In modifications of the fourth to the seventh embodiments above, the color of the surface of each of the panel-end-surface-facing portions 324, 424, 524, and 624 may be other than black, such as gray.

(9) In a modification of the fifth embodiment above, the color of the surface of the second panel supporting member 422 may be other than white, such as gray.

(10) In modifications of the first to the fourth embodiments and the sixth to the tenth embodiments, the color of the surfaces of the second panel supporting members 22, 122, 322, 522, 822, and 922 may be other than black, such as gray.

(11) In a modification of the sixth embodiment above, a light absorbing portion 26 can be provided on a facing surface of the outer edge of the liquid crystal panel 511 that faces the first panel supporting portion 513A.

(12) In a modification of the sixth embodiment above, the specific number of split panel-end-surface-facing portions 524S and the specific number of split inclined surfaces 524AS can be changed as appropriate. The plurality of split panel-end-surface-facing portions 524S may be disposed side by side in a direction of inclination with respect to the Z-axis direction. Alternatively, the inclination angles of the plurality of split inclined surfaces 524AS may differ.

(13) In modifications of the sixth and the seventh embodiments above, the panel-end-surface-facing portions 524 and 624 may be integrated with the first panel supporting member or the second panel supporting member 522.

(14) In a modification of the eight embodiment above, the light absorbing portion 26 may be mounted on the outer edge of the liquid crystal panel 711.

(15) The embodiments and the modifications described above can obviously be combined as appropriate.

(16) The specific inclination angles of the inclined surfaces 24A, 124A, 224A, 324A, 424A, 524A, 624A, 724A, 824A, and 924A with respect to a corresponding one of the display surfaces 11DS and 711DS can be changed as appropriate. For example, in the structures of the first to the seventh embodiments above and the ninth and the tenth embodiments above, the inclination angles of the inclined surfaces 24A, 124A, 224A, 324A, 424A, 524A, 624A, 824A, and 924A may be less than 30° and greater than 60°. In the structure of the eight embodiment above, the inclination angle of the inclined surface 724A may be less than 60° and greater than 80°.

(17) The inclined surfaces 24A, 124A, 224A, 324A, 424A, 524A, 624A, 724A, 824A, and 924A are not limited to those that are each provided over the entire area in the Z-axis direction of a corresponding one of the panel-end-surface-facing portions 24, 324, 424, 524, 624, 724, 824, and 924, and may those that are each disposed in part of the entire area.

(18) The interval maintaining portions 22B, 322B, 422B, and 522B may be omitted.

(19) The liquid crystal display devices 10, 510, and 710 may have a planar shape other than a substantially quadrangular shape that is horizontally long, such as a substantially quadrangular shape that is vertically long, a substantially square shape, or a shape that is not a substantially quadrangular shape (a substantially circular shape, a substantially elliptical shape, a substantially trapezoidal shape, etc.).

(20) The specific structure of each of the backlight devices 12 and 412 can be changed as appropriate. For example, the specific number of optical members 17 that are stacked upon each other and the types of optical members 17 and the specific number of optical members 417 that are stacked upon each other and the types of optical members 417 can be changed as appropriate. The light sources can be, for example, organic EL light sources, in addition to being the LEDs 18. The diffusing lenses 20 can be omitted.

(21) The backlight devices 12 and 412 may each be, for example, an edge-light backlight device, in addition to being a direct backlight device.

(22) The liquid crystal panels 11, 111, 211, 311, 411, 511, 611, and 711 may each be a reflection type liquid crystal panel or a transflective type liquid crystal panel, in addition to being a transmissive liquid crystal panel. In the case of the reflection type, the backlight devices 12 and 412 can be omitted.

(23) The display devices 10, 510, and 710 may be those using types of display panels other than a corresponding one of the liquid crystal panels 11, 111, 211, 311, 411, 511, 611, and 711 (such types including organic EL display panels). In this case, depending upon the type of display panel, the backlight devices 12 and 412 can be omitted.

(24) The specific number of flexible substrates 14 that are set can be changed as appropriate to specific numbers of flexible substrates 14 other than those illustrated in the figures. The gate-side flexible substrates 14B that are included among the flexible substrates 14 may be mounted on only one of the short side portions of a corresponding one of the liquid crystal panels 11, 111, 211, 311, 411, 511, 611, and 711. Further, the gate-side flexible substrates 14B can be omitted, in which case a gate circuit section having a function that is equivalent to that of the gate drivers can be formed in a monolithic form on the array substrate 11B. However, other structures are possible. The source drivers 14A1 can be omitted from the source-side flexible substrates 14A, in which case, the source drivers 14A1 can be mounted on the array substrate 11B by COG (Chip On Glass) mounting. However, other structures are possible.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a display panel that has a display surface on which an image is to be displayed;
a first panel supporting portion that is disposed so as to face a side of the display surface in a normal direction to the display surface with respect to an outer edge of the display panel and that is capable of supporting the outer edge;
a second panel supporting portion that is disposed so as to face a side opposite to the side of the display surface in the normal direction with respect to the outer edge and that is capable of supporting the outer edge; and
a panel-end-surface-facing portion that is disposed so as to be interposed between the first panel supporting portion and the second panel supporting portion in the normal direction and that is disposed so as to face an end surface of the display panel, at least a part of a facing surface of the panel-end-surface-facing portion that faces the end surface of the display panel being an inclined surface that is inclined with respect to the normal direction.

2. The display device according to claim 1, comprising:
an interval maintaining portion that is disposed so as to be interposed between the first panel supporting portion and the second panel supporting portion in the normal direction and that maintains an interval between the first panel supporting portion and the second panel supporting portion.

3. The display device according to claim 2, wherein the panel-end-surface-facing portion is integrated with the interval maintaining portion.

4. The display device according to claim 2, wherein the panel-end-surface-facing portion is disposed so as to be adjacent to a side of the end surface of the display panel with respect to the interval maintaining portion and is mounted on at least the interval maintaining portion.

5. The display device according to claim 4, wherein the second panel supporting portion is integrated with the interval maintaining portion and has a light absorbance that is lower than a light absorbance of the panel-end-surface-facing portion and has a light reflectance that is higher than a light reflectance of the panel-end-surface-facing portion.

6. The display device according to claim 2, wherein the first panel supporting portion, the second panel supporting portion, and the interval maintaining portion each extend along the outer edge of the display panel, and wherein the interval maintaining portion includes a wide-width portion that partly has a wide width.

7. The display device according to claim 6, wherein the wide-width portion is disposed closer to a position of an end than to a position of a center of the interval maintaining portion in an extension direction.

8. The display device according to claim 7, wherein the panel-end-surface-facing portion having the inclined surface is selectively provided at a position at which the wide-width portion is not disposed in the extension direction of the interval maintaining portion, and wherein the wide-width portion is in contact with the end surface of the display panel.

9. The display device according to claim 8, wherein the wide-width portion is disposed so as to be spaced apart toward a side of the center from the position of the end of the interval maintaining portion in the extension direction, and
wherein the panel-end-surface-facing portion having the inclined surface is spaced apart from the end surface of the display panel.

10. The display device according to claim 1, wherein a gradient of the inclined surface is set so that the inclined surface slopes away from the end surface of the display panel as the panel-end-surface-facing portion becomes nearer to a side of the first panel supporting portion from a side of the second panel supporting portion in the normal direction.

11. The display device according to claim 1, wherein a gradient of the inclined surface is set so that the inclined surface slopes toward the end surface of the display panel as the panel-end-surface-facing portion becomes nearer to a side of the first panel supporting portion from a side of the second panel supporting portion in the normal direction.

12. The display device according to claim 1, wherein the panel-end-surface-facing portion includes a plurality of split panel-end-surface-facing portions that are disposed so as to overlap each other in the normal direction, and
wherein the inclined surface includes a plurality of split inclined surfaces of the plurality of split panel-end-surface-facing portions.

13. The display device according to claim 1, wherein a light absorbing portion having a light absorbance that is higher than a light absorbance of the first panel supporting portion is provided on at least one of a facing surface of the first panel supporting portion that faces the display panel and a facing surface of the display panel that faces the first panel supporting portion.

14. The display device according to claim 1, wherein the inclined surface is roughened.

15. The display device according to claim 1, comprising:
an illuminating device that is disposed on the side opposite to the display surface in the normal direction with respect to the display panel and that illuminates the display panel with display light.
